(19) United States
(12) Patent Application Publication
(10) Pub. No.: US 2026/0132631 A1
(43) Pub. Date: May 14, 2026

(54) ROOFING MEMBRANE, AND ROOFING SYSTEM INCLUDING THE ROOFING MEMBRANE

(71) Applicant: BMIC LLC, Dallas, TX (US)

(72) Inventors: Paul Lem, Mountain Lakes, NJ (US); Linlin Xing, Wayne, NJ (US)

(21) Appl. No.: 19/444,827

(22) Filed: Jan. 9, 2026

Related U.S. Application Data
(63) Continuation of application No. PCT/US2024/034965, filed on Jun. 21, 2024.
(60) Provisional application No. 63/514,252, filed on Jul. 18, 2023.

(51) Int. Cl. E04D 5/06; E04D 5/10

(52) U.S. Cl. CPC E04D 5/06; E04D 5/10

(57) ABSTRACT

A roofing membrane, including: a first layer, where the first layer includes: 30 wt. % to 65 wt. %, based on a total weight of the first layer, of magnesium hydroxide, and a thermoplastic polyolefin (TPO); a second layer, where the second layer includes a scrim material, where the scrim material includes a polyester material; and a third layer, where the second layer is between the first layer and the third layer, where the third layer includes: 30 wt. % to 65 wt. %, based on a total weight of the third layer, of magnesium hydroxide, and a thermoplastic polyolefin (TPO).

### CROSS-REFERENCE TO RELATED APPLICATIONS

This application is a continuation of International patent application no. PCT/US2024/034965, titled “ROOFING MEMBRANE, AND ROOFING SYSTEM INCLUDING THE ROOFING MEMBRANE,” filed Jun. 21, 2024 which claims priority to U.S. provisional application No. 63/514,252, titled “ROOFING MEMBRANE, AND ROOFING SYSTEM INCLUDING THE ROOFING MEMBRANE,” filed Jul. 18, 2023, the disclosure of which are incorporated by reference herein in their entirety.

### FIELD

The present invention is directed to a roofing membrane, and, more particularly, to an enhanced fire-resistant roofing membrane.

### BACKGROUND

A roofing membrane installed above a roof deck may provide a degree of fire-protection. Often, roofing materials, such as roofing shingles, cover the installed roofing membranes.

### SUMMARY

The Claims, rather than the Summary, define covered embodiments of the present invention. The Summary is a high-level overview of various aspects of the invention, and introduces some concepts that are further described in the Detailed Description below. The Summary is not intended to identify key or essential features of the claimed subject matter, and also is not intended to be used in isolation to determine the scope of the claimed subject matter. Instead, the claimed subject matter should be understood by reference to appropriate portions of the Specification and drawings, as well as to each claim.

In some embodiments, the present invention provides a roofing membrane, comprising: a first layer, wherein the first layer comprises at least 30 wt. % of magnesium hydroxide, and a thermoplastic polyolefin (TPO); a second layer, wherein the second layer comprises a scrim material, wherein the scrim material comprises a polyester material; and a third layer, wherein the second layer is between the first layer and the third layer, wherein the third layer comprises at least 30 wt. % of magnesium hydroxide, and a thermoplastic polyolefin (TPO).

In some embodiments, the first layer contacts and at least partially covers the second layer.

In some embodiments, the second layer contacts and at least partially covers the third layer.

In some embodiments, the first layer comprises at least 42 wt. % of magnesium hydroxide.

In some embodiments, the third layer comprises at least 42 wt. % of magnesium hydroxide.

In some embodiments, the first layer comprises at least 52 wt. % of magnesium hydroxide.

In some embodiments, the third layer comprises at least 52 wt. % of magnesium hydroxide.

In some embodiments, the present invention provides a roofing system, comprising: a roofing substrate; and a roofing membrane installed directly on the roofing substrate, the roofing membrane comprising: a first layer, wherein the first layer is an uppermost layer of the roofing membrane, wherein the first layer comprises at least 30 wt. % of magnesium hydroxide, and a thermoplastic polyolefin (TPO); a second layer, wherein the second layer comprises a scrim material, wherein the scrim material comprises a polyester material; and a third layer, wherein the second layer is between the first layer and the third layer, wherein the third layer comprises at least 30 wt. % of magnesium hydroxide, and a thermoplastic polyolefin (TPO), wherein, when tested in accordance with European fire testing standards BRoof (t2) or (t3), one or more of the roofing system, the roofing membrane, and/or the roofing substrate passes the testing.

In some embodiments, the roofing substrate comprises an expanded polystyrene material.

In some embodiments, the expanded polystyrene material has a thickness of at least 0.5″ or above.

In some embodiments, the roofing substrate comprise a polyisocyanurate material.

In some embodiments, the polyisocyanurate material has a thickness of at least 0.5″ or above.

In some embodiments, the roofing membrane contacts the roofing substrate, such that there is no intervening layer between the roofing substrate and the roofing membrane.

In some embodiments, the present invention provides a roofing system, comprising: a roofing substrate; a fire-resistant layer directly on the roofing substrate; and a roofing membrane directly on the fire-resistant layer, such that the fire-resistant layer is between the roofing substrate and the roofing membrane, wherein the roofing membrane comprises: a first layer, wherein the first layer is an uppermost layer of the roofing membrane, wherein the first layer comprises at least 30 wt. % of magnesium hydroxide, and a thermoplastic polyolefin (TPO); a second layer, wherein the second layer comprises a scrim material, wherein the scrim material comprises a polyester material; and a third layer, wherein the second layer is between the first layer and the third layer, wherein the third layer comprises at least 30 wt. % of magnesium hydroxide, and a thermoplastic polyolefin (TPO), wherein, when tested in accordance with European fire testing standards BRoof (t2) or (t3), one or more of the roofing system, the roofing membrane, and/or the roofing substrate passes the testing.

In some embodiments, fire-resistant layer comprises glass fleece.

In some embodiments, the fire-resistant layer has a thickness of 60 mil.

### BRIEF DESCRIPTION OF THE DRAWINGS

This section refers to the drawings that form a part of this disclosure, and which illustrate some of the embodiments of structure, materials, and/or methods of the present invention described herein.

FIG. 1 is a schematic showing a cross-sectional view of a roofing membrane, in accordance with some embodiments of the invention.

FIG. 2 is a schematic showing a cross-sectional view of a roofing system comprising the roofing membrane, a fire-resistant layer, and a substrate, in accordance with some embodiments of the invention.

FIG. 3 is a schematic showing a cross-sectional view of a roofing system comprising the roofing membrane and the substrate, in accordance with some embodiments of the invention.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

As used herein, a “steep slope” roof or roof deck is a roof or roof deck having a pitch of Y/X, where Y and X are in a ratio of 4:12 to 20:12, where Y corresponds to the “rise” of the roof or roof deck, and where X corresponds to the “run” of the roof or roof deck.

As used herein, a “sloped” roof or roof deck is a roof or roof deck having a pitch greater than zero, but the pitch is less than that of a steep slope roof or roof deck.

As used herein, a “low slope” roof or roof deck is a roof or roof deck having a pitch of Y/X, where Y and X are in a ratio of less than 4:12.

As used herein, a “flat” roof or roof deck is a roof or roof deck having a pitch of zero. In some embodiments, a “flat” roof or roof deck includes a low slope roof or roof deck.

In some embodiments, the present invention provides a roofing membrane.

In some embodiments, the disclosed roofing membrane is installed on a roof or roof deck. In some embodiments, the roof or roof deck is a steep slope roof or roof deck. In some embodiments, the roof or roof deck is a sloped roof or roof deck. In some embodiments, the roof or roof deck is flat.

In some embodiments, the roofing membrane is configured to be installed above or on a substrate. In some embodiments, the substrate is configured to be installed above or on the roof or roof deck.

In some embodiments, the roofing membrane includes a first layer. In some embodiments, the first layer includes magnesium hydroxide and thermoplastic polyolefin (TPO). In some embodiments, the roofing membrane includes a second layer. In some embodiments, the second layer includes a scrim material. In some embodiments, the roofing membrane includes a third layer. In some embodiments, the first layer includes magnesium hydroxide and thermoplastic polyolefin (TPO). In some embodiments, the second layer is between the first layer and the third layer.

In some embodiments, there is a sufficient amount of the magnesium hydroxide in at least the first layer such that, when the roofing membrane is installed above a substrate and tested in accordance with European fire testing standards BRoof (t2) or (t3), one or more of the roofing membrane and/or the roofing substrate passes the testing. In some embodiments, there is a sufficient amount of the magnesium hydroxide in at least the third layer such that, when the roofing membrane is installed above the substrate and tested in accordance with European fire testing standards BRoof (t2) or (t3), one or more of the roofing membrane and/or the roofing substrate passes the testing. In some embodiments, there is a sufficient amount of the magnesium hydroxide in the first layer and the third layer such that, when the roofing membrane is installed above the substrate and tested in accordance with European fire testing standards BRoof (t2) or (t3), one or more of the roofing membrane and/or the roofing substrate passes the testing.

In some embodiments, the percentage (on a weight basis) of magnesium hydroxide in the first layer based on the total weight of the total layer is the same as the percentage (on a weight basis) of magnesium hydroxide in the third layer based on the total weight of the total layer. In some embodiments, the percentage magnesium hydroxide in the first layer is substantially the same as the percentage of magnesium hydroxide in the third layer. In some embodiments, the percentage of magnesium hydroxide in the first layer is different than the percentage of magnesium hydroxide in the third layer. In some embodiments, the percentage of magnesium hydroxide in the first layer is greater than the percentage of magnesium hydroxide in the third layer. In some embodiments, the percentage of magnesium hydroxide in the first layer is less than the percentage of magnesium hydroxide in the third layer.

In some embodiments, the first layer includes 20 wt. % of magnesium hydroxide, based on a total weight of the first layer. In some embodiments, the first layer includes 25 wt. % of magnesium hydroxide. In some embodiments, the first layer includes 30 wt. % of magnesium hydroxide. In some embodiments, the first layer includes 31 wt. % of magnesium hydroxide. In some embodiments, the first layer includes 32 wt. % of magnesium hydroxide. In some embodiments, the first layer includes 33 wt. % of magnesium hydroxide. In some embodiments, the first layer includes 34 wt. % of magnesium hydroxide. In some embodiments, the first layer includes 35 wt. % of magnesium hydroxide. In some embodiments, the first layer includes 36 wt. % of magnesium hydroxide. In some embodiments, the first layer includes 37 wt. % of magnesium hydroxide. In some embodiments, the first layer includes 38 wt. % of magnesium hydroxide. In some embodiments, the first layer includes 39 wt. % of magnesium hydroxide. In some embodiments, the first layer includes 40 wt. % of magnesium hydroxide. In some embodiments, the first layer includes 41 wt. % of magnesium hydroxide. In some embodiments, the first layer includes 42 wt. % of magnesium hydroxide. In some embodiments, the first layer includes 43 wt. % of magnesium hydroxide. In some embodiments, the first layer includes 44 wt. % of magnesium hydroxide. In some embodiments, the first layer includes 45 wt. % of magnesium hydroxide. In some embodiments, the first layer includes 46 wt. % of magnesium hydroxide. In some embodiments, the first layer includes 47 wt. % of magnesium hydroxide. In some embodiments, the first layer includes 48 wt. % of magnesium hydroxide. In some embodiments, the first layer includes 49 wt. % of magnesium hydroxide. In some embodiments, the first layer includes 50 wt. % of magnesium hydroxide. In some embodiments, the first layer includes 51 wt. % of magnesium hydroxide. In some embodiments, the first layer includes 52 wt. % of magnesium hydroxide. In some embodiments, the first layer includes 53 wt. % of magnesium hydroxide. In some embodiments, the first layer includes 54 wt. % of magnesium hydroxide. In some embodiments, the first layer includes 55 wt. % of magnesium hydroxide. In some embodiments, the first layer includes 60 wt. % of magnesium hydroxide. In some embodiments, the first layer includes 65 wt. % of magnesium hydroxide.

In some embodiments, the first layer includes at least 20 wt. % of magnesium hydroxide. In some embodiments, the first layer includes at least 25 wt. % of magnesium hydroxide. In some embodiments, the first layer includes at least 30 wt. % of magnesium hydroxide. In some embodiments, the first layer includes at least 31 wt. % of magnesium hydroxide. In some embodiments, the first layer includes at least 32 wt. % of magnesium hydroxide. In some embodiments, the first layer includes at least 33 wt. % of magnesium hydroxide. In some embodiments, the first layer includes at least 34 wt. % of magnesium hydroxide. In some embodiments, the first layer includes at least 35 wt. % of magnesium hydroxide. In some embodiments, the first layer includes at least 36 wt. % of magnesium hydroxide. In some embodiments, the first layer includes at least 37 wt. % of magnesium hydroxide. In some embodiments, the first layer includes at least 38 wt. % of magnesium hydroxide. In some embodiments, the first layer includes at least 39 wt. % of magnesium hydroxide. In some embodiments, the first layer includes at least 40 wt. % of magnesium hydroxide. In some embodiments, the first layer includes at least 41 wt. % of magnesium hydroxide. In some embodiments, the first layer includes at least 42 wt. % of magnesium hydroxide. In some embodiments, the first layer includes at least 43 wt. % of magnesium hydroxide. In some embodiments, the first layer includes at least 44 wt. % of magnesium hydroxide. In some embodiments, the first layer includes at least 45 wt. % of magnesium hydroxide. In some embodiments, the first layer includes at least 46wt. % of magnesium hydroxide. In some embodiments, the first layer includes at least 47 wt. % of magnesium hydroxide. In some embodiments, the first layer includes at least 48 wt. % of magnesium hydroxide. In some embodiments, the first layer includes at least 49 wt. % of magnesium hydroxide. In some embodiments, the first layer includes at least 50 wt. % of magnesium hydroxide. In some embodiments, the first layer includes at least 51 wt. % of magnesium hydroxide. In some embodiments, the first layer includes at least 52 wt. % of magnesium hydroxide. In some embodiments, the first layer includes at least 53 wt. % of magnesium hydroxide. In some embodiments, the first layer includes at least 54 wt. % of magnesium hydroxide. In some embodiments, the first layer includes at least 55 wt. % of magnesium hydroxide. In some embodiments, the first layer includes at least 60 wt. % of magnesium hydroxide. In some embodiments, the first layer includes at least 65 wt. % of magnesium hydroxide.

In some embodiments, the first layer includes less than 20 wt. % of magnesium hydroxide. In some embodiments, the first layer includes less than 25 wt. % of magnesium hydroxide. In some embodiments, the first layer includes less than 30 wt. % of magnesium hydroxide. In some embodiments, the first layer includes less than 31 wt. % of magnesium hydroxide. In some embodiments, the first layer includes less than 32wt. % of magnesium hydroxide. In some embodiments, the first layer includes less than 33 wt. % of magnesium hydroxide. In some embodiments, the first layer includes less than 34 wt. % of magnesium hydroxide. In some embodiments, the first layer includes less than 35 wt. % of magnesium hydroxide. In some embodiments, the first layer includes less than 36 wt. % of magnesium hydroxide. In some embodiments, the first layer includes less than 37 wt. % of magnesium hydroxide. In some embodiments, the first layer includes less than 38 wt. % of magnesium hydroxide. In some embodiments, the first layer includes less than 39 wt. % of magnesium hydroxide. In some embodiments, the first layer includes less than 40 wt. % of magnesium hydroxide. In some embodiments, the first layer includes less than 41 wt. % of magnesium hydroxide. In some embodiments, the first layer includes less than 42 wt. % of magnesium hydroxide. In some embodiments, the first layer includes less than 43 wt. % of magnesium hydroxide. In some embodiments, the first layer includes less than 44 wt. % of magnesium hydroxide. In some embodiments, the first layer includes less than 45 wt. % of magnesium hydroxide. In some embodiments, the first layer includes less than 46wt. % of magnesium hydroxide. In some embodiments, the first layer includes less than 47 wt. % of magnesium hydroxide. In some embodiments, the first layer includes less than 48 wt. % of magnesium hydroxide. In some embodiments, the first layer includes less than 49 wt. % of magnesium hydroxide. In some embodiments, the first layer includes less than 50 wt. % of magnesium hydroxide. In some embodiments, the first layer includes less than 51 wt. % of magnesium hydroxide. In some embodiments, the first layer includes less than 52 wt. % of magnesium hydroxide. In some embodiments, the first layer includes less than 53 wt. % of magnesium hydroxide. In some embodiments, the first layer includes less than 54 wt. % of magnesium hydroxide. In some embodiments, the first layer includes less than 55 wt. % of magnesium hydroxide. In some embodiments, the first layer includes less than 60 wt. % of magnesium hydroxide. In some embodiments, the first layer includes less than 65 wt. % of magnesium hydroxide.

In some embodiments, the first layer includes 20% to 65 wt. % of magnesium hydroxide. In some embodiments, the first layer includes 25% to 65 wt. % of magnesium hydroxide. In some embodiments, the first layer includes 30% to 65 wt. % of magnesium hydroxide. In some embodiments, the first layer includes 31% to 65 wt. % of magnesium hydroxide. In some embodiments, the first layer includes 32% to 65 wt. % of magnesium hydroxide. In some embodiments, the first layer includes 33% to 65 wt. % of magnesium hydroxide. In some embodiments, the first layer includes 34% to 65 wt. % of magnesium hydroxide. In some embodiments, the first layer includes 35% to 65 wt. % of magnesium hydroxide. In some embodiments, the first layer includes 36% to 65 wt. % of magnesium hydroxide. In some embodiments, the first layer includes 37% to 65 wt. % of magnesium hydroxide. In some embodiments, the first layer includes 38% to 65 wt. % of magnesium hydroxide. In some embodiments, the first layer includes 39% to 65 wt. % of magnesium hydroxide. In some embodiments, the first layer includes 40% to 65 wt. % of magnesium hydroxide. In some embodiments, the first layer includes 41% to 65 wt. % of magnesium hydroxide. In some embodiments, the first layer includes 42% to 65 wt. % of magnesium hydroxide. In some embodiments, the first layer includes 43% to 65 wt. % of magnesium hydroxide. In some embodiments, the first layer includes 44% to 65 wt. % of magnesium hydroxide. In some embodiments, the first layer includes 45% to 65 wt. % of magnesium hydroxide. In some embodiments, the first layer includes 46% to 65 wt. % of magnesium hydroxide. In some embodiments, the first layer includes 47% to 65 wt. % of magnesium hydroxide. In some embodiments, the first layer includes 48% to 65 wt. % of magnesium hydroxide. In some embodiments, the first layer includes 49% to 65 wt. % of magnesium hydroxide. In some embodiments, the first layer includes 50% to 65 wt. % of magnesium hydroxide. In some embodiments, the first layer includes 51% to 65 wt. % of magnesium hydroxide. In some embodiments, the first layer includes 52% to 65 wt. % of magnesium hydroxide. In some embodiments, the first layer includes 53% to 65 wt. % of magnesium hydroxide. In some embodiments, the first layer includes 54% to 65 wt. % of magnesium hydroxide. In some embodiments, the first layer includes 55% to 65 wt. % of magnesium hydroxide. In some embodiments, the first layer includes 60% to 65 wt. % of magnesium hydroxide.

In some embodiments, the first layer includes 20% to 60 wt. % of magnesium hydroxide. In some embodiments, the first layer includes 25% to 60 wt. % of magnesium hydroxide. In some embodiments, the first layer includes 30% to 60 wt. % of magnesium hydroxide. In some embodiments, the first layer includes 31% to 60 wt. % of magnesium hydroxide. In some embodiments, the first layer includes 32% to 60 wt. % of magnesium hydroxide. In some embodiments, the first layer includes 33% to 60 wt. % of magnesium hydroxide. In some embodiments, the first layer includes 34% to 60 wt. % of magnesium hydroxide. In some embodiments, the first layer includes 35% to 60 wt. % of magnesium hydroxide. In some embodiments, the first layer includes 36% to 60 wt. % of magnesium hydroxide. In some embodiments, the first layer includes 37% to 60 wt. % of magnesium hydroxide. In some embodiments, the first layer includes 38% to 60 wt. % of magnesium hydroxide. In some embodiments, the first layer includes 39% to 60 wt. % of magnesium hydroxide. In some embodiments, the first layer includes 40% to 60 wt. % of magnesium hydroxide. In some embodiments, the first layer includes 41% to 60 wt. % of magnesium hydroxide. In some embodiments, the first layer includes 42% to 60 wt. % of magnesium hydroxide. In some embodiments, the first layer includes 43% to 60 wt. % of magnesium hydroxide. In some embodiments, the first layer includes 44% to 60 wt. % of magnesium hydroxide. In some embodiments, the first layer includes 45% to 60 wt. % of magnesium hydroxide. In some embodiments, the first layer includes 46% to 60 wt. % of magnesium hydroxide. In some embodiments, the first layer includes 47% to 60 wt. % of magnesium hydroxide. In some embodiments, the first layer includes 48% to 60 wt. % of magnesium hydroxide. In some embodiments, the first layer includes 49% to 60 wt. % of magnesium hydroxide. In some embodiments, the first layer includes 50% to 60 wt. % of magnesium hydroxide. In some embodiments, the first layer includes 51% to 60 wt. % of magnesium hydroxide. In some embodiments, the first layer includes 52% to 60 wt. % of magnesium hydroxide. In some embodiments, the first layer includes 53% to 60 wt. % of magnesium hydroxide. In some embodiments, the first layer includes 54% to 60 wt. % of magnesium hydroxide. In some embodiments, the first layer includes 55% to 60 wt. % of magnesium hydroxide.

In some embodiments, the first layer includes 20% to 55 wt. % of magnesium hydroxide. In some embodiments, the first layer includes 25% to 55 wt. % of magnesium hydroxide. In some embodiments, the first layer includes 30% to 55 wt. % of magnesium hydroxide. In some embodiments, the first layer includes 31% to 55 wt. % of magnesium hydroxide. In some embodiments, the first layer includes 32% to 55 wt. % of magnesium hydroxide. In some embodiments, the first layer includes 33% to 55 wt. % of magnesium hydroxide. In some embodiments, the first layer includes 34% to 55 wt. % of magnesium hydroxide. In some embodiments, the first layer includes 35% to 55 wt. % of magnesium hydroxide. In some embodiments, the first layer includes 36% to 55 wt. % of magnesium hydroxide. In some embodiments, the first layer includes 37% to 55 wt. % of magnesium hydroxide. In some embodiments, the first layer includes 38% to 55 wt. % of magnesium hydroxide. In some embodiments, the first layer includes 39% to 55 wt. % of magnesium hydroxide. In some embodiments, the first layer includes 40% to 55 wt. % of magnesium hydroxide. In some embodiments, the first layer includes 41% to 55 wt. % of magnesium hydroxide. In some embodiments, the first layer includes 42% to 55 wt. % of magnesium hydroxide. In some embodiments, the first layer includes 43% to 55 wt. % of magnesium hydroxide. In some embodiments, the first layer includes 44% to 55 wt. % of magnesium hydroxide. In some embodiments, the first layer includes 45% to 55 wt. % of magnesium hydroxide. In some embodiments, the first layer includes 46% to 55 wt. % of magnesium hydroxide. In some embodiments, the first layer includes 47% to 55 wt. % of magnesium hydroxide. In some embodiments, the first layer includes 48% to 55 wt. % of magnesium hydroxide. In some embodiments, the first layer includes 49% to 55 wt. % of magnesium hydroxide. In some embodiments, the first layer includes 50% to 55 wt. % of magnesium hydroxide. In some embodiments, the first layer includes 51% to 55 wt. % of magnesium hydroxide. In some embodiments, the first layer includes 52% to 55 wt. % of magnesium hydroxide. In some embodiments, the first layer includes 53% to 55 wt. % of magnesium hydroxide. In some embodiments, the first layer includes 54% to 55 wt. % of magnesium hydroxide.

In some embodiments, the first layer includes 20% to 54 wt. % of magnesium hydroxide. In some embodiments, the first layer includes 25% to 54 wt. % of magnesium hydroxide. In some embodiments, the first layer includes 30% to 54 wt. % of magnesium hydroxide. In some embodiments, the first layer includes 31% to 54 wt. % of magnesium hydroxide. In some embodiments, the first layer includes 32% to 54wt. % of magnesium hydroxide. In some embodiments, the first layer includes 33% to 54 wt. % of magnesium hydroxide. In some embodiments, the first layer includes 34% to 54 wt. % of magnesium hydroxide. In some embodiments, the first layer includes 35% to 54 wt. % of magnesium hydroxide. In some embodiments, the first layer includes 36% to 54 wt. % of magnesium hydroxide. In some embodiments, the first layer includes 37% to 54 wt. % of magnesium hydroxide. In some embodiments, the first layer includes 38% to 54 wt. % of magnesium hydroxide. In some embodiments, the first layer includes 39% to 54 wt. % of magnesium hydroxide. In some embodiments, the first layer includes 40% to 54 wt. % of magnesium hydroxide. In some embodiments, the first layer includes 41% to 54 wt. % of magnesium hydroxide. In some embodiments, the first layer includes 42% to 54 wt. % of magnesium hydroxide. In some embodiments, the first layer includes 43% to 54 wt. % of magnesium hydroxide. In some embodiments, the first layer includes 44% to 54 wt. % of magnesium hydroxide. In some embodiments, the first layer includes 45% to 54 wt. % of magnesium hydroxide. In some embodiments, the first layer includes 46% to 54wt. % of magnesium hydroxide. In some embodiments, the first layer includes 47% to 54 wt. % of magnesium hydroxide. In some embodiments, the first layer includes 48% to 54 wt. % of magnesium hydroxide. In some embodiments, the first layer includes 49% to 54 wt. % of magnesium hydroxide. In some embodiments, the first layer includes 50% to 54 wt. % of magnesium hydroxide. In some embodiments, the first layer includes 51% to 54 wt. % of magnesium hydroxide. In some embodiments, the first layer includes 52% to 54 wt. % of magnesium hydroxide. In some embodiments, the first layer includes 53% to 54 wt. % of magnesium hydroxide.

In some embodiments, the first layer includes 20% to 53 wt. % of magnesium hydroxide. In some embodiments, the first layer includes 25% to 53 wt. % of magnesium hydroxide. In some embodiments, the first layer includes 30% to 53 wt. % of magnesium hydroxide. In some embodiments, the first layer includes 31% to 53 wt. % of magnesium hydroxide. In some embodiments, the first layer includes 32% to 53 wt. % of magnesium hydroxide. In some embodiments, the first layer includes 33% to 53 wt. % of magnesium hydroxide. In some embodiments, the first layer includes 34% to 53 wt. % of magnesium hydroxide. In some embodiments, the first layer includes 35% to 53 wt. % of magnesium hydroxide. In some embodiments, the first layer includes 36% to 53 wt. % of magnesium hydroxide. In some embodiments, the first layer includes 37% to 53 wt. % of magnesium hydroxide. In some embodiments, the first layer includes 38% to 53 wt. % of magnesium hydroxide. In some embodiments, the first layer includes 39% to 53 wt. % of magnesium hydroxide. In some embodiments, the first layer includes 40% to 53 wt. % of magnesium hydroxide. In some embodiments, the first layer includes 41% to 53 wt. % of magnesium hydroxide. In some embodiments, the first layer includes 42% to 53 wt. % of magnesium hydroxide. In some embodiments, the first layer includes 43% to 53 wt. % of magnesium hydroxide. In some embodiments, the first layer includes 44% to 53 wt. % of magnesium hydroxide. In some embodiments, the first layer includes 45% to 53 wt. % of magnesium hydroxide. In some embodiments, the first layer includes 46% to 53 wt. % of magnesium hydroxide. In some embodiments, the first layer includes 47% to 53 wt. % of magnesium hydroxide. In some embodiments, the first layer includes 48% to 53 wt. % of magnesium hydroxide. In some embodiments, the first layer includes 49% to 53 wt. % of magnesium hydroxide. In some embodiments, the first layer includes 50% to 53 wt. % of magnesium hydroxide. In some embodiments, the first layer includes 51% to 53 wt. % of magnesium hydroxide. In some embodiments, the first layer includes 52% to 53 wt. % of magnesium hydroxide.

In some embodiments, the first layer includes 20% to 52 wt. % of magnesium hydroxide. In some embodiments, the first layer includes 25% to 52 wt. % of magnesium hydroxide. In some embodiments, the first layer includes 30% to 52 wt. % of magnesium hydroxide. In some embodiments, the first layer includes 31% to 52 wt. % of magnesium hydroxide. In some embodiments, the first layer includes 32% to 52 wt. % of magnesium hydroxide. In some embodiments, the first layer includes 33% to 52 wt. % of magnesium hydroxide. In some embodiments, the first layer includes 34% to 52 wt. % of magnesium hydroxide. In some embodiments, the first layer includes 35% to 52 wt. % of magnesium hydroxide. In some embodiments, the first layer includes 36% to 52 wt. % of magnesium hydroxide. In some embodiments, the first layer includes 37% to 52 wt. % of magnesium hydroxide. In some embodiments, the first layer includes 38% to 52 wt. % of magnesium hydroxide. In some embodiments, the first layer includes 39% to 52 wt. % of magnesium hydroxide. In some embodiments, the first layer includes 40% to 52 wt. % of magnesium hydroxide. In some embodiments, the first layer includes 41% to 52 wt. % of magnesium hydroxide. In some embodiments, the first layer includes 42% to 52 wt. % of magnesium hydroxide. In some embodiments, the first layer includes 43% to 52 wt. % of magnesium hydroxide. In some embodiments, the first layer includes 44% to 52 wt. % of magnesium hydroxide. In some embodiments, the first layer includes 45% to 52 wt. % of magnesium hydroxide. In some embodiments, the first layer includes 46% to 52 wt. % of magnesium hydroxide. In some embodiments, the first layer includes 47% to 52 wt. % of magnesium hydroxide. In some embodiments, the first layer includes 48% to 52 wt. % of magnesium hydroxide. In some embodiments, the first layer includes 49% to 52 wt. % of magnesium hydroxide. In some embodiments, the first layer includes 50% to 52 wt. % of magnesium hydroxide. In some embodiments, the first layer includes 51% to 52 wt. % of magnesium hydroxide.

In some embodiments, the first layer includes 20% to 51 wt. % of magnesium hydroxide. In some embodiments, the first layer includes 25% to 51 wt. % of magnesium hydroxide. In some embodiments, the first layer includes 30% to 51 wt. % of magnesium hydroxide. In some embodiments, the first layer includes 31% to 51 wt. % of magnesium hydroxide. In some embodiments, the first layer includes 32% to 51 wt. % of magnesium hydroxide. In some embodiments, the first layer includes 33% to 51 wt. % of magnesium hydroxide. In some embodiments, the first layer includes 34% to 51 wt. % of magnesium hydroxide. In some embodiments, the first layer includes 35% to 51 wt. % of magnesium hydroxide. In some embodiments, the first layer includes 36% to 51 wt. % of magnesium hydroxide. In some embodiments, the first layer includes 37% to 51 wt. % of magnesium hydroxide. In some embodiments, the first layer includes 38% to 51 wt. % of magnesium hydroxide. In some embodiments, the first layer includes 39% to 51 wt. % of magnesium hydroxide. In some embodiments, the first layer includes 40% to 51 wt. % of magnesium hydroxide. In some embodiments, the first layer includes 41% to 51 wt. % of magnesium hydroxide. In some embodiments, the first layer includes 42% to 51 wt. % of magnesium hydroxide. In some embodiments, the first layer includes 43% to 51 wt. % of magnesium hydroxide. In some embodiments, the first layer includes 44% to 51 wt. % of magnesium hydroxide. In some embodiments, the first layer includes 45% to 51 wt. % of magnesium hydroxide. In some embodiments, the first layer includes 46% to 51 wt. % of magnesium hydroxide. In some embodiments, the first layer includes 47% to 51 wt. % of magnesium hydroxide. In some embodiments, the first layer includes 48% to 51 wt. % of magnesium hydroxide. In some embodiments, the first layer includes 49% to 51 wt. % of magnesium hydroxide. In some embodiments, the first layer includes 50% to 51 wt. % of magnesium hydroxide.

In some embodiments, the first layer includes 20% to 50 wt. % of magnesium hydroxide. In some embodiments, the first layer includes 25% to 50 wt. % of magnesium hydroxide. In some embodiments, the first layer includes 30% to 50 wt. % of magnesium hydroxide. In some embodiments, the first layer includes 31% to 50 wt. % of magnesium hydroxide. In some embodiments, the first layer includes 32% to 50 wt. % of magnesium hydroxide. In some embodiments, the first layer includes 33% to 50 wt. % of magnesium hydroxide. In some embodiments, the first layer includes 34% to 50 wt. % of magnesium hydroxide. In some embodiments, the first layer includes 35% to 50 wt. % of magnesium hydroxide. In some embodiments, the first layer includes 36% to 50 wt. % of magnesium hydroxide. In some embodiments, the first layer includes 37% to 50 wt. % of magnesium hydroxide. In some embodiments, the first layer includes 38% to 50 wt. % of magnesium hydroxide. In some embodiments, the first layer includes 39% to 50 wt. % of magnesium hydroxide. In some embodiments, the first layer includes 40% to 50 wt. % of magnesium hydroxide. In some embodiments, the first layer includes 41% to 50 wt. % of magnesium hydroxide. In some embodiments, the first layer includes 42% to 50 wt. % of magnesium hydroxide. In some embodiments, the first layer includes 43% to 50 wt. % of magnesium hydroxide. In some embodiments, the first layer includes 44% to 50 wt. % of magnesium hydroxide. In some embodiments, the first layer includes 45% to 50 wt. % of magnesium hydroxide. In some embodiments, the first layer includes 46% to 50 wt. % of magnesium hydroxide. In some embodiments, the first layer includes 47% to 50 wt. % of magnesium hydroxide. In some embodiments, the first layer includes 48% to 50 wt. % of magnesium hydroxide. In some embodiments, the first layer includes 49% to 50 wt. % of magnesium hydroxide.

In some embodiments, the first layer includes 20% to 49 wt. % of magnesium hydroxide. In some embodiments, the first layer includes 25% to 49 wt. % of magnesium hydroxide. In some embodiments, the first layer includes 30% to 49 wt. % of magnesium hydroxide. In some embodiments, the first layer includes 31% to 49 wt. % of magnesium hydroxide. In some embodiments, the first layer includes 32% to 49 wt. % of magnesium hydroxide. In some embodiments, the first layer includes 33% to 49 wt. % of magnesium hydroxide. In some embodiments, the first layer includes 34% to 49 wt. % of magnesium hydroxide. In some embodiments, the first layer includes 35% to 49 wt. % of magnesium hydroxide. In some embodiments, the first layer includes 36% to 49 wt. % of magnesium hydroxide. In some embodiments, the first layer includes 37% to 49 wt. % of magnesium hydroxide. In some embodiments, the first layer includes 38% to 49 wt. % of magnesium hydroxide. In some embodiments, the first layer includes 39% to 49 wt. % of magnesium hydroxide. In some embodiments, the first layer includes 40% to 49 wt. % of magnesium hydroxide. In some embodiments, the first layer includes 41% to 49 wt. % of magnesium hydroxide. In some embodiments, the first layer includes 42% to 49 wt. % of magnesium hydroxide. In some embodiments, the first layer includes 43% to 49 wt. % of magnesium hydroxide. In some embodiments, the first layer includes 44% to 49 wt. % of magnesium hydroxide. In some embodiments, the first layer includes 45% to 49 wt. % of magnesium hydroxide. In some embodiments, the first layer includes 46% to 49 wt. % of magnesium hydroxide. In some embodiments, the first layer includes 47% to 49 wt. % of magnesium hydroxide. In some embodiments, the first layer includes 48% to 49 wt. % of magnesium hydroxide.

In some embodiments, the first layer includes 20% to 48 wt. % of magnesium hydroxide. In some embodiments, the first layer includes 25% to 48 wt. % of magnesium hydroxide. In some embodiments, the first layer includes 30% to 48 wt. % of magnesium hydroxide. In some embodiments, the first layer includes 31% to 48 wt. % of magnesium hydroxide. In some embodiments, the first layer includes 32% to 48 wt. % of magnesium hydroxide. In some embodiments, the first layer includes 33% to 48 wt. % of magnesium hydroxide. In some embodiments, the first layer includes 34% to 48 wt. % of magnesium hydroxide. In some embodiments, the first layer includes 35% to 48 wt. % of magnesium hydroxide. In some embodiments, the first layer includes 36% to 48 wt. % of magnesium hydroxide. In some embodiments, the first layer includes 37% to 48 wt. % of magnesium hydroxide. In some embodiments, the first layer includes 38% to 48 wt. % of magnesium hydroxide. In some embodiments, the first layer includes 39% to 48 wt. % of magnesium hydroxide. In some embodiments, the first layer includes 40% to 48 wt. % of magnesium hydroxide. In some embodiments, the first layer includes 41% to 48 wt. % of magnesium hydroxide. In some embodiments, the first layer includes 42% to 48 wt. % of magnesium hydroxide. In some embodiments, the first layer includes 43% to 48 wt. % of magnesium hydroxide. In some embodiments, the first layer includes 44% to 48 wt. % of magnesium hydroxide. In some embodiments, the first layer includes 45% to 48 wt. % of magnesium hydroxide. In some embodiments, the first layer includes 46% to 48 wt. % of magnesium hydroxide. In some embodiments, the first layer includes 47% to 48 wt. % of magnesium hydroxide.

In some embodiments, the first layer includes 20% to 47 wt. % of magnesium hydroxide. In some embodiments, the first layer includes 25% to 47 wt. % of magnesium hydroxide. In some embodiments, the first layer includes 30% to 47 wt. % of magnesium hydroxide. In some embodiments, the first layer includes 31% to 47 wt. % of magnesium hydroxide. In some embodiments, the first layer includes 32% to 47 wt. % of magnesium hydroxide. In some embodiments, the first layer includes 33% to 47 wt. % of magnesium hydroxide. In some embodiments, the first layer includes 34% to 47 wt. % of magnesium hydroxide. In some embodiments, the first layer includes 35% to 47 wt. % of magnesium hydroxide. In some embodiments, the first layer includes 36% to 47 wt. % of magnesium hydroxide. In some embodiments, the first layer includes 37% to 47 wt. % of magnesium hydroxide. In some embodiments, the first layer includes 38% to 47 wt. % of magnesium hydroxide. In some embodiments, the first layer includes 39% to 47 wt. % of magnesium hydroxide. In some embodiments, the first layer includes 40% to 47 wt. % of magnesium hydroxide. In some embodiments, the first layer includes 41% to 47 wt. % of magnesium hydroxide. In some embodiments, the first layer includes 42% to 47 wt. % of magnesium hydroxide. In some embodiments, the first layer includes 43% to 47 wt. % of magnesium hydroxide. In some embodiments, the first layer includes 44% to 47 wt. % of magnesium hydroxide. In some embodiments, the first layer includes 45% to 47 wt. % of magnesium hydroxide. In some embodiments, the first layer includes 46% to 47 wt. % of magnesium hydroxide.

In some embodiments, the first layer includes 20% to 46 wt. % of magnesium hydroxide. In some embodiments, the first layer includes 25% to 46 wt. % of magnesium hydroxide. In some embodiments, the first layer includes 30% to 46 wt. % of magnesium hydroxide. In some embodiments, the first layer includes 31% to 46 wt. % of magnesium hydroxide. In some embodiments, the first layer includes 32% to 46 wt. % of magnesium hydroxide. In some embodiments, the first layer includes 33% to 46 wt. % of magnesium hydroxide. In some embodiments, the first layer includes 34% to 46 wt. % of magnesium hydroxide. In some embodiments, the first layer includes 35% to 46 wt. % of magnesium hydroxide. In some embodiments, the first layer includes 36% to 46 wt. % of magnesium hydroxide. In some embodiments, the first layer includes 37% to 46 wt. % of magnesium hydroxide. In some embodiments, the first layer includes 38% to 46 wt. % of magnesium hydroxide. In some embodiments, the first layer includes 39% to 46 wt. % of magnesium hydroxide. In some embodiments, the first layer includes 40% to 46 wt. % of magnesium hydroxide. In some embodiments, the first layer includes 41% to 46 wt. % of magnesium hydroxide. In some embodiments, the first layer includes 42% to 46 wt. % of magnesium hydroxide. In some embodiments, the first layer includes 43% to 46 wt. % of magnesium hydroxide. In some embodiments, the first layer includes 44% to 46 wt. % of magnesium hydroxide. In some embodiments, the first layer includes 45% to 46 wt. % of magnesium hydroxide.

In some embodiments, the first layer includes 20% to 45 wt. % of magnesium hydroxide. In some embodiments, the first layer includes 25% to 45 wt. % of magnesium hydroxide. In some embodiments, the first layer includes 30% to 45 wt. % of magnesium hydroxide. In some embodiments, the first layer includes 31% to 45 wt. % of magnesium hydroxide. In some embodiments, the first layer includes 32% to 45 wt. % of magnesium hydroxide. In some embodiments, the first layer includes 33% to 45 wt. % of magnesium hydroxide. In some embodiments, the first layer includes 34% to 45 wt. % of magnesium hydroxide. In some embodiments, the first layer includes 35% to 45 wt. % of magnesium hydroxide. In some embodiments, the first layer includes 36% to 45 wt. % of magnesium hydroxide. In some embodiments, the first layer includes 37% to 45 wt. % of magnesium hydroxide. In some embodiments, the first layer includes 38% to 45 wt. % of magnesium hydroxide. In some embodiments, the first layer includes 39% to 45 wt. % of magnesium hydroxide. In some embodiments, the first layer includes 40% to 45 wt. % of magnesium hydroxide. In some embodiments, the first layer includes 41% to 45 wt. % of magnesium hydroxide. In some embodiments, the first layer includes 42% to 45 wt. % of magnesium hydroxide. In some embodiments, the first layer includes 43% to 45 wt. % of magnesium hydroxide. In some embodiments, the first layer includes 44% to 45 wt. % of magnesium hydroxide.

In some embodiments, the first layer includes 20% to 44 wt. % of magnesium hydroxide. In some embodiments, the first layer includes 25% to 44 wt. % of magnesium hydroxide. In some embodiments, the first layer includes 30% to 44 wt. % of magnesium hydroxide. In some embodiments, the first layer includes 31% to 44 wt. % of magnesium hydroxide. In some embodiments, the first layer includes 32% to 44 wt. % of magnesium hydroxide. In some embodiments, the first layer includes 33% to 44 wt. % of magnesium hydroxide. In some embodiments, the first layer includes 34% to 44 wt. % of magnesium hydroxide. In some embodiments, the first layer includes 35% to 44 wt. % of magnesium hydroxide. In some embodiments, the first layer includes 36% to 44 wt. % of magnesium hydroxide. In some embodiments, the first layer includes 37% to 44 wt. % of magnesium hydroxide. In some embodiments, the first layer includes 38% to 44 wt. % of magnesium hydroxide. In some embodiments, the first layer includes 39% to 44 wt. % of magnesium hydroxide. In some embodiments, the first layer includes 40% to 44 wt. % of magnesium hydroxide. In some embodiments, the first layer includes 41% to 44 wt. % of magnesium hydroxide. In some embodiments, the first layer includes 42% to 44 wt. % of magnesium hydroxide. In some embodiments, the first layer includes 43% to 44 wt. % of magnesium hydroxide.

In some embodiments, the first layer includes 20% to 43 wt. % of magnesium hydroxide. In some embodiments, the first layer includes 25% to 43 wt. % of magnesium hydroxide. In some embodiments, the first layer includes 30% to 43 wt. % of magnesium hydroxide. In some embodiments, the first layer includes 31% to 43 wt. % of magnesium hydroxide. In some embodiments, the first layer includes 32% to 43 wt. % of magnesium hydroxide. In some embodiments, the first layer includes 33% to 43 wt. % of magnesium hydroxide. In some embodiments, the first layer includes 34% to 43 wt. % of magnesium hydroxide. In some embodiments, the first layer includes 35% to 43 wt. % of magnesium hydroxide. In some embodiments, the first layer includes 36% to 43 wt. % of magnesium hydroxide. In some embodiments, the first layer includes 37% to 43 wt. % of magnesium hydroxide. In some embodiments, the first layer includes 38% to 43 wt. % of magnesium hydroxide. In some embodiments, the first layer includes 39% to 43 wt. % of magnesium hydroxide. In some embodiments, the first layer includes 40% to 43 wt. % of magnesium hydroxide. In some embodiments, the first layer includes 41% to 43 wt. % of magnesium hydroxide. In some embodiments, the first layer includes 42% to 43 wt. % of magnesium hydroxide.

In some embodiments, the first layer includes 20% to 42 wt. % of magnesium hydroxide. In some embodiments, the first layer includes 25% to 42 wt. % of magnesium hydroxide. In some embodiments, the first layer includes 30% to 42 wt. % of magnesium hydroxide. In some embodiments, the first layer includes 31% to 42 wt. % of magnesium hydroxide. In some embodiments, the first layer includes 32% to 42 wt. % of magnesium hydroxide. In some embodiments, the first layer includes 33% to 42 wt. % of magnesium hydroxide. In some embodiments, the first layer includes 34% to 42 wt. % of magnesium hydroxide. In some embodiments, the first layer includes 35% to 42 wt. % of magnesium hydroxide. In some embodiments, the first layer includes 36% to 42 wt. % of magnesium hydroxide. In some embodiments, the first layer includes 37% to 42 wt. % of magnesium hydroxide. In some embodiments, the first layer includes 38% to 42 wt. % of magnesium hydroxide. In some embodiments, the first layer includes 39% to 42 wt. % of magnesium hydroxide. In some embodiments, the first layer includes 40% to 42 wt. % of magnesium hydroxide. In some embodiments, the first layer includes 41% to 42 wt. % of magnesium hydroxide.

In some embodiments, the first layer includes 20% to 41 wt. % of magnesium hydroxide. In some embodiments, the first layer includes 25% to 41 wt. % of magnesium hydroxide. In some embodiments, the first layer includes 30% to 41 wt. % of magnesium hydroxide. In some embodiments, the first layer includes 31% to 41 wt. % of magnesium hydroxide. In some embodiments, the first layer includes 32% to 41 wt. % of magnesium hydroxide. In some embodiments, the first layer includes 33% to 41 wt. % of magnesium hydroxide. In some embodiments, the first layer includes 34% to 41 wt. % of magnesium hydroxide. In some embodiments, the first layer includes 35% to 41 wt. % of magnesium hydroxide. In some embodiments, the first layer includes 36% to 41 wt. % of magnesium hydroxide. In some embodiments, the first layer includes 37% to 41 wt. % of magnesium hydroxide. In some embodiments, the first layer includes 38% to 41 wt. % of magnesium hydroxide. In some embodiments, the first layer includes 39% to 41 wt. % of magnesium hydroxide. In some embodiments, the first layer includes 40% to 41 wt. % of magnesium hydroxide.

In some embodiments, the first layer includes 20% to 40 wt. % of magnesium hydroxide. In some embodiments, the first layer includes 25% to 40 wt. % of magnesium hydroxide. In some embodiments, the first layer includes 30% to 40 wt. % of magnesium hydroxide. In some embodiments, the first layer includes 31% to 40 wt. % of magnesium hydroxide. In some embodiments, the first layer includes 32% to 40 wt. % of magnesium hydroxide. In some embodiments, the first layer includes 33% to 40 wt. % of magnesium hydroxide. In some embodiments, the first layer includes 34% to 40 wt. % of magnesium hydroxide. In some embodiments, the first layer includes 35% to 40 wt. % of magnesium hydroxide. In some embodiments, the first layer includes 36% to 40 wt. % of magnesium hydroxide. In some embodiments, the first layer includes 37% to 40 wt. % of magnesium hydroxide. In some embodiments, the first layer includes 38% to 40 wt. % of magnesium hydroxide. In some embodiments, the first layer includes 39% to 40 wt. % of magnesium hydroxide.

In some embodiments, the first layer includes 20% to 39 wt. % of magnesium hydroxide. In some embodiments, the first layer includes 25% to 39 wt. % of magnesium hydroxide. In some embodiments, the first layer includes 30% to 39 wt. % of magnesium hydroxide. In some embodiments, the first layer includes 31% to 39 wt. % of magnesium hydroxide. In some embodiments, the first layer includes 32% to 39 wt. % of magnesium hydroxide. In some embodiments, the first layer includes 33% to 39 wt. % of magnesium hydroxide. In some embodiments, the first layer includes 34% to 39 wt. % of magnesium hydroxide. In some embodiments, the first layer includes 35% to 39 wt. % of magnesium hydroxide. In some embodiments, the first layer includes 36% to 39 wt. % of magnesium hydroxide. In some embodiments, the first layer includes 37% to 39 wt. % of magnesium hydroxide. In some embodiments, the first layer includes 38% to 39 wt. % of magnesium hydroxide.

In some embodiments, the first layer includes 20% to 38 wt. % of magnesium hydroxide. In some embodiments, the first layer includes 25% to 38 wt. % of magnesium hydroxide. In some embodiments, the first layer includes 30% to 38 wt. % of magnesium hydroxide. In some embodiments, the first layer includes 31% to 38 wt. % of magnesium hydroxide. In some embodiments, the first layer includes 32% to 38 wt. % of magnesium hydroxide. In some embodiments, the first layer includes 33% to 38 wt. % of magnesium hydroxide. In some embodiments, the first layer includes 34% to 38 wt. % of magnesium hydroxide. In some embodiments, the first layer includes 35% to 38 wt. % of magnesium hydroxide. In some embodiments, the first layer includes 36% to 38 wt. % of magnesium hydroxide. In some embodiments, the first layer includes 37% to 38 wt. % of magnesium hydroxide.

In some embodiments, the first layer includes 20% to 37 wt. % of magnesium hydroxide. In some embodiments, the first layer includes 25% to 37 wt. % of magnesium hydroxide. In some embodiments, the first layer includes 30% to 37 wt. % of magnesium hydroxide. In some embodiments, the first layer includes 31% to 37 wt. % of magnesium hydroxide. In some embodiments, the first layer includes 32% to 37 wt. % of magnesium hydroxide. In some embodiments, the first layer includes 33% to 37 wt. % of magnesium hydroxide. In some embodiments, the first layer includes 34% to 37 wt. % of magnesium hydroxide. In some embodiments, the first layer includes 35% to 37 wt. % of magnesium hydroxide. In some embodiments, the first layer includes 36% to 37 wt. % of magnesium hydroxide.

In some embodiments, the first layer includes 20% to 36 wt. % of magnesium hydroxide. In some embodiments, the first layer includes 25% to 36 wt. % of magnesium hydroxide. In some embodiments, the first layer includes 30% to 36 wt. % of magnesium hydroxide. In some embodiments, the first layer includes 31% to 36 wt. % of magnesium hydroxide. In some embodiments, the first layer includes 32% to 36 wt. % of magnesium hydroxide. In some embodiments, the first layer includes 33% to 36 wt. % of magnesium hydroxide. In some embodiments, the first layer includes 34% to 36 wt. % of magnesium hydroxide. In some embodiments, the first layer includes 35% to 36 wt. % of magnesium hydroxide.

In some embodiments, the first layer includes 20% to 35 wt. % of magnesium hydroxide. In some embodiments, the first layer includes 25% to 35 wt. % of magnesium hydroxide. In some embodiments, the first layer includes 30% to 35 wt. % of magnesium hydroxide. In some embodiments, the first layer includes 31% to 35 wt. % of magnesium hydroxide. In some embodiments, the first layer includes 32% to 35 wt. % of magnesium hydroxide. In some embodiments, the first layer includes 33% to 35 wt. % of magnesium hydroxide. In some embodiments, the first layer includes 34% to 35 wt. % of magnesium hydroxide.

In some embodiments, the first layer includes 20% to 34 wt. % of magnesium hydroxide. In some embodiments, the first layer includes 25% to 34 wt. % of magnesium hydroxide. In some embodiments, the first layer includes 30% to 34 wt. % of magnesium hydroxide. In some embodiments, the first layer includes 31% to 34 wt. % of magnesium hydroxide. In some embodiments, the first layer includes 32% to 34 wt. % of magnesium hydroxide. In some embodiments, the first layer includes 33% to 34 wt. % of magnesium hydroxide.

In some embodiments, the first layer includes 20% to 33 wt. % of magnesium hydroxide. In some embodiments, the first layer includes 25% to 33 wt. % of magnesium hydroxide. In some embodiments, the first layer includes 30% to 33 wt. % of magnesium hydroxide. In some embodiments, the first layer includes 31% to 33 wt. % of magnesium hydroxide. In some embodiments, the first layer includes 32% to 33 wt. % of magnesium hydroxide.

In some embodiments, the first layer includes 20% to 32 wt. % of magnesium hydroxide. In some embodiments, the first layer includes 25% to 32 wt. % of magnesium hydroxide. In some embodiments, the first layer includes 30% to 32 wt. % of magnesium hydroxide. In some embodiments, the first layer includes 31% to 32 wt. % of magnesium hydroxide.

In some embodiments, the first layer includes 20% to 31 wt. % of magnesium hydroxide. In some embodiments, the first layer includes 25% to 31 wt. % of magnesium hydroxide. In some embodiments, the first layer includes 30% to 31 wt. % of magnesium hydroxide.

In some embodiments, the first layer includes 20% to 30 wt. % of magnesium hydroxide. In some embodiments, the first layer includes 25% to 30 wt. % of magnesium hydroxide. In some embodiments, the first layer includes 20% to 25 wt. % of magnesium hydroxide.

In some embodiments, the third layer includes 20 wt. % of magnesium hydroxide. In some embodiments, the third layer includes 25 wt. % of magnesium hydroxide. In some embodiments, the third layer includes 30 wt. % of magnesium hydroxide. In some embodiments, the third layer includes 31 wt. % of magnesium hydroxide. In some embodiments, the third layer includes 32 wt. % of magnesium hydroxide. In some embodiments, the third layer includes 33 wt. % of magnesium hydroxide. In some embodiments, the third layer includes 34 wt. % of magnesium hydroxide. In some embodiments, the third layer includes 35 wt. % of magnesium hydroxide. In some embodiments, the third layer includes 36 wt. % of magnesium hydroxide. In some embodiments, the third layer includes 37 wt. % of magnesium hydroxide. In some embodiments, the third layer includes 38 wt. % of magnesium hydroxide. In some embodiments, the third layer includes 39 wt. % of magnesium hydroxide. In some embodiments, the third layer includes 40 wt. % of magnesium hydroxide. In some embodiments, the third layer includes 41 wt. % of magnesium hydroxide. In some embodiments, the third layer includes 42 wt. % of magnesium hydroxide. In some embodiments, the third layer includes 43 wt. % of magnesium hydroxide. In some embodiments, the third layer includes 44 wt. % of magnesium hydroxide. In some embodiments, the third layer includes 45 wt. % of magnesium hydroxide. In some embodiments, the third layer includes 46 wt. % of magnesium hydroxide. In some embodiments, the third layer includes 47 wt. % of magnesium hydroxide. In some embodiments, the third layer includes 48 wt. % of magnesium hydroxide. In some embodiments, the third layer includes 49 wt. % of magnesium hydroxide. In some embodiments, the third layer includes 50 wt. % of magnesium hydroxide. In some embodiments, the third layer includes 51 wt. % of magnesium hydroxide. In some embodiments, the third layer includes 52 wt. % of magnesium hydroxide. In some embodiments, the third layer includes 53 wt. % of magnesium hydroxide. In some embodiments, the third layer includes 54 wt. % of magnesium hydroxide. In some embodiments, the third layer includes 55 wt. % of magnesium hydroxide. In some embodiments, the third layer includes 60 wt. % of magnesium hydroxide. In some embodiments, the third layer includes 65 wt. % of magnesium hydroxide.

In some embodiments, the third layer includes at least 20 wt. % of magnesium hydroxide. In some embodiments, the third layer includes at least 25 wt. % of magnesium hydroxide. In some embodiments, the third layer includes at least 30 wt. % of magnesium hydroxide. In some embodiments, the third layer includes at least 31 wt. % of magnesium hydroxide. In some embodiments, the third layer includes at least 32 wt. % of magnesium hydroxide. In some embodiments, the third layer includes at least 33 wt. % of magnesium hydroxide. In some embodiments, the third layer includes at least 34 wt. % of magnesium hydroxide. In some embodiments, the third layer includes at least 35 wt. % of magnesium hydroxide. In some embodiments, the third layer includes at least 36 wt. % of magnesium hydroxide. In some embodiments, the third layer includes at least 37 wt. % of magnesium hydroxide. In some embodiments, the third layer includes at least 38 wt. % of magnesium hydroxide. In some embodiments, the third layer includes at least 39 wt. % of magnesium hydroxide. In some embodiments, the third layer includes at least 40 wt. % of magnesium hydroxide. In some embodiments, the third layer includes at least 41 wt. % of magnesium hydroxide. In some embodiments, the third layer includes at least 42 wt. % of magnesium hydroxide. In some embodiments, the third layer includes at least 43 wt. % of magnesium hydroxide. In some embodiments, the third layer includes at least 44 wt. % of magnesium hydroxide. In some embodiments, the third layer includes at least 45 wt. % of magnesium hydroxide. In some embodiments, the third layer includes at least 46 wt. % of magnesium hydroxide. In some embodiments, the third layer includes at least 47 wt. % of magnesium hydroxide. In some embodiments, the third layer includes at least 48 wt. % of magnesium hydroxide. In some embodiments, the third layer includes at least 49 wt. % of magnesium hydroxide. In some embodiments, the third layer includes at least 50 wt. % of magnesium hydroxide. In some embodiments, the third layer includes at least 51 wt. % of magnesium hydroxide. In some embodiments, the third layer includes at least 52 wt. % of magnesium hydroxide. In some embodiments, the third layer includes at least 53 wt. % of magnesium hydroxide. In some embodiments, the third layer includes at least 54 wt. % of magnesium hydroxide. In some embodiments, the third layer includes at least 55 wt. % of magnesium hydroxide. In some embodiments, the third layer includes at least 60 wt. % of magnesium hydroxide. In some embodiments, the third layer includes at least 65 wt. % of magnesium hydroxide.

In some embodiments, the third layer includes less than 20 wt. % of magnesium hydroxide. In some embodiments, the third layer includes less than 25 wt. % of magnesium hydroxide. In some embodiments, the third layer includes less than 30 wt. % of magnesium hydroxide. In some embodiments, the third layer includes less than 31 wt. % of magnesium hydroxide. In some embodiments, the third layer includes less than 32 wt. % of magnesium hydroxide. In some embodiments, the third layer includes less than 33 wt. % of magnesium hydroxide. In some embodiments, the third layer includes less than 34 wt. % of magnesium hydroxide. In some embodiments, the third layer includes less than 35 wt. % of magnesium hydroxide. In some embodiments, the third layer includes less than 36 wt. % of magnesium hydroxide. In some embodiments, the third layer includes less than 37 wt. % of magnesium hydroxide. In some embodiments, the third layer includes less than 38 wt. % of magnesium hydroxide. In some embodiments, the third layer includes less than 39 wt. % of magnesium hydroxide. In some embodiments, the third layer includes less than 40 wt. % of magnesium hydroxide. In some embodiments, the third layer includes less than 41 wt. % of magnesium hydroxide. In some embodiments, the third layer includes less than 42 wt. % of magnesium hydroxide. In some embodiments, the third layer includes less than 43 wt. % of magnesium hydroxide. In some embodiments, the third layer includes less than 44 wt. % of magnesium hydroxide. In some embodiments, the third layer includes less than 45 wt. % of magnesium hydroxide. In some embodiments, the third layer includes less than 46 wt. % of magnesium hydroxide. In some embodiments, the third layer includes less than 47 wt. % of magnesium hydroxide. In some embodiments, the third layer includes less than 48 wt. % of magnesium hydroxide. In some embodiments, the third layer includes less than 49 wt. % of magnesium hydroxide. In some embodiments, the third layer includes less than 50 wt. % of magnesium hydroxide. In some embodiments, the third layer includes less than 51 wt. % of magnesium hydroxide. In some embodiments, the third layer includes less than 52 wt. % of magnesium hydroxide. In some embodiments, the third layer includes less than 53 wt. % of magnesium hydroxide. In some embodiments, the third layer includes less than 54 wt. % of magnesium hydroxide. In some embodiments, the third layer includes less than 55 wt. % of magnesium hydroxide. In some embodiments, the third layer includes less than 60 wt. % of magnesium hydroxide. In some embodiments, the third layer includes less than 65 wt. % of magnesium hydroxide.

In some embodiments, the third layer includes 20% to 65 wt. % of magnesium hydroxide. In some embodiments, the third layer includes 25% to 65 wt. % of magnesium hydroxide. In some embodiments, the third layer includes 30% to 65 wt. % of magnesium hydroxide. In some embodiments, the third layer includes 31% to 65 wt. % of magnesium hydroxide. In some embodiments, the third layer includes 32% to 65 wt. % of magnesium hydroxide. In some embodiments, the third layer includes 33% to 65 wt. % of magnesium hydroxide. In some embodiments, the third layer includes 34% to 65 wt. % of magnesium hydroxide. In some embodiments, the third layer includes 35% to 65 wt. % of magnesium hydroxide. In some embodiments, the third layer includes 36% to 65 wt. % of magnesium hydroxide. In some embodiments, the third layer includes 37% to 65 wt. % of magnesium hydroxide. In some embodiments, the third layer includes 38% to 65 wt. % of magnesium hydroxide. In some embodiments, the third layer includes 39% to 65 wt. % of magnesium hydroxide. In some embodiments, the third layer includes 40% to 65 wt. % of magnesium hydroxide. In some embodiments, the third layer includes 41% to 65 wt. % of magnesium hydroxide. In some embodiments, the third layer includes 42% to 65 wt. % of magnesium hydroxide. In some embodiments, the third layer includes 43% to 65 wt. % of magnesium hydroxide. In some embodiments, the third layer includes 44% to 65 wt. % of magnesium hydroxide. In some embodiments, the third layer includes 45% to 65 wt. % of magnesium hydroxide. In some embodiments, the third layer includes 46% to 65 wt. % of magnesium hydroxide. In some embodiments, the third layer includes 47% to 65 wt. % of magnesium hydroxide. In some embodiments, the third layer includes 48% to 65 wt. % of magnesium hydroxide. In some embodiments, the third layer includes 49% to 65 wt. % of magnesium hydroxide. In some embodiments, the third layer includes 50% to 65 wt. % of magnesium hydroxide. In some embodiments, the third layer includes 51% to 65 wt. % of magnesium hydroxide. In some embodiments, the third layer includes 52% to 65 wt. % of magnesium hydroxide. In some embodiments, the third layer includes 53% to 65 wt. % of magnesium hydroxide. In some embodiments, the third layer includes 54% to 65 wt. % of magnesium hydroxide. In some embodiments, the third layer includes 55% to 65 wt. % of magnesium hydroxide. In some embodiments, the third layer includes 60% to 65 wt. % of magnesium hydroxide.

In some embodiments, the third layer includes 20% to 60 wt. % of magnesium hydroxide. In some embodiments, the third layer includes 25% to 60 wt. % of magnesium hydroxide. In some embodiments, the third layer includes 30% to 60 wt. % of magnesium hydroxide. In some embodiments, the third layer includes 31% to 60 wt. % of magnesium hydroxide. In some embodiments, the third layer includes 32% to 60 wt. % of magnesium hydroxide. In some embodiments, the third layer includes 33% to 60 wt. % of magnesium hydroxide. In some embodiments, the third layer includes 34% to 60 wt. % of magnesium hydroxide. In some embodiments, the third layer includes 35% to 60 wt. % of magnesium hydroxide. In some embodiments, the third layer includes 36% to 60 wt. % of magnesium hydroxide. In some embodiments, the third layer includes 37% to 60 wt. % of magnesium hydroxide. In some embodiments, the third layer includes 38% to 60 wt. % of magnesium hydroxide. In some embodiments, the third layer includes 39% to 60 wt. % of magnesium hydroxide. In some embodiments, the third layer includes 40% to 60 wt. % of magnesium hydroxide. In some embodiments, the third layer includes 41% to 60 wt. % of magnesium hydroxide. In some embodiments, the third layer includes 42% to 60 wt. % of magnesium hydroxide. In some embodiments, the third layer includes 43% to 60 wt. % of magnesium hydroxide. In some embodiments, the third layer includes 44% to 60 wt. % of magnesium hydroxide. In some embodiments, the third layer includes 45% to 60 wt. % of magnesium hydroxide. In some embodiments, the third layer includes 46% to 60 wt. % of magnesium hydroxide. In some embodiments, the third layer includes 47% to 60 wt. % of magnesium hydroxide. In some embodiments, the third layer includes 48% to 60 wt. % of magnesium hydroxide. In some embodiments, the third layer includes 49% to 60 wt. % of magnesium hydroxide. In some embodiments, the third layer includes 50% to 60 wt. % of magnesium hydroxide. In some embodiments, the third layer includes 51% to 60 wt. % of magnesium hydroxide. In some embodiments, the third layer includes 52% to 60 wt. % of magnesium hydroxide. In some embodiments, the third layer includes 53% to 60 wt. % of magnesium hydroxide. In some embodiments, the third layer includes 54% to 60 wt. % of magnesium hydroxide. In some embodiments, the third layer includes 55% to 60 wt. % of magnesium hydroxide.

In some embodiments, the third layer includes 20% to 55 wt. % of magnesium hydroxide. In some embodiments, the third layer includes 25% to 55 wt. % of magnesium hydroxide. In some embodiments, the third layer includes 30% to 55 wt. % of magnesium hydroxide. In some embodiments, the third layer includes 31% to 55 wt. % of magnesium hydroxide. In some embodiments, the third layer includes 32% to 55 wt. % of magnesium hydroxide. In some embodiments, the third layer includes 33% to 55 wt. % of magnesium hydroxide. In some embodiments, the third layer includes 34% to 55 wt. % of magnesium hydroxide. In some embodiments, the third layer includes 35% to 55 wt. % of magnesium hydroxide. In some embodiments, the third layer includes 36% to 55 wt. % of magnesium hydroxide. In some embodiments, the third layer includes 37% to 55 wt. % of magnesium hydroxide. In some embodiments, the third layer includes 38% to 55 wt. % of magnesium hydroxide. In some embodiments, the third layer includes 39% to 55 wt. % of magnesium hydroxide. In some embodiments, the third layer includes 40% to 55 wt. % of magnesium hydroxide. In some embodiments, the third layer includes 41% to 55 wt. % of magnesium hydroxide. In some embodiments, the third layer includes 42% to 55 wt. % of magnesium hydroxide. In some embodiments, the third layer includes 43% to 55 wt. % of magnesium hydroxide. In some embodiments, the third layer includes 44% to 55 wt. % of magnesium hydroxide. In some embodiments, the third layer includes 45% to 55 wt. % of magnesium hydroxide. In some embodiments, the third layer includes 46% to 55 wt. % of magnesium hydroxide. In some embodiments, the third layer includes 47% to 55 wt. % of magnesium hydroxide. In some embodiments, the third layer includes 48% to 55 wt. % of magnesium hydroxide. In some embodiments, the third layer includes 49% to 55 wt. % of magnesium hydroxide. In some embodiments, the third layer includes 50% to 55 wt. % of magnesium hydroxide. In some embodiments, the third layer includes 51% to 55 wt. % of magnesium hydroxide. In some embodiments, the third layer includes 52% to 55 wt. % of magnesium hydroxide. In some embodiments, the third layer includes 53% to 55 wt. % of magnesium hydroxide. In some embodiments, the third layer includes 54% to 55 wt. % of magnesium hydroxide.

In some embodiments, the third layer includes 20% to 54 wt. % of magnesium hydroxide. In some embodiments, the third layer includes 25% to 54 wt. % of magnesium hydroxide. In some embodiments, the third layer includes 30% to 54 wt. % of magnesium hydroxide. In some embodiments, the third layer includes 31% to 54 wt. % of magnesium hydroxide. In some embodiments, the third layer includes 32% to 54 wt. % of magnesium hydroxide. In some embodiments, the third layer includes 33% to 54 wt. % of magnesium hydroxide. In some embodiments, the third layer includes 34% to 54 wt. % of magnesium hydroxide. In some embodiments, the third layer includes 35% to 54 wt. % of magnesium hydroxide. In some embodiments, the third layer includes 36% to 54 wt. % of magnesium hydroxide. In some embodiments, the third layer includes 37% to 54 wt. % of magnesium hydroxide. In some embodiments, the third layer includes 38% to 54 wt. % of magnesium hydroxide. In some embodiments, the third layer includes 39% to 54 wt. % of magnesium hydroxide. In some embodiments, the third layer includes 40% to 54 wt. % of magnesium hydroxide. In some embodiments, the third layer includes 41% to 54 wt. % of magnesium hydroxide. In some embodiments, the third layer includes 42% to 54 wt. % of magnesium hydroxide. In some embodiments, the third layer includes 43% to 54 wt. % of magnesium hydroxide. In some embodiments, the third layer includes 44% to 54 wt. % of magnesium hydroxide. In some embodiments, the third layer includes 45% to 54 wt. % of magnesium hydroxide. In some embodiments, the third layer includes 46% to 54 wt. % of magnesium hydroxide. In some embodiments, the third layer includes 47% to 54 wt. % of magnesium hydroxide. In some embodiments, the third layer includes 48% to 54 wt. % of magnesium hydroxide. In some embodiments, the third layer includes 49% to 54 wt. % of magnesium hydroxide. In some embodiments, the third layer includes 50% to 54 wt. % of magnesium hydroxide. In some embodiments, the third layer includes 51% to 54 wt. % of magnesium hydroxide. In some embodiments, the third layer includes 52% to 54 wt. % of magnesium hydroxide. In some embodiments, the third layer includes 53% to 54 wt. % of magnesium hydroxide.

In some embodiments, the third layer includes 20% to 53 wt. % of magnesium hydroxide. In some embodiments, the third layer includes 25% to 53 wt. % of magnesium hydroxide. In some embodiments, the third layer includes 30% to 53 wt. % of magnesium hydroxide. In some embodiments, the third layer includes 31% to 53 wt. % of magnesium hydroxide. In some embodiments, the third layer includes 32% to 53 wt. % of magnesium hydroxide. In some embodiments, the third layer includes 33% to 53 wt. % of magnesium hydroxide. In some embodiments, the third layer includes 34% to 53 wt. % of magnesium hydroxide. In some embodiments, the third layer includes 35% to 53 wt. % of magnesium hydroxide. In some embodiments, the third layer includes 36% to 53 wt. % of magnesium hydroxide. In some embodiments, the third layer includes 37% to 53 wt. % of magnesium hydroxide. In some embodiments, the third layer includes 38% to 53 wt. % of magnesium hydroxide. In some embodiments, the third layer includes 39% to 53 wt. % of magnesium hydroxide. In some embodiments, the third layer includes 40% to 53 wt. % of magnesium hydroxide. In some embodiments, the third layer includes 41% to 53 wt. % of magnesium hydroxide.

In some embodiments, the third layer includes 42% to 53 wt. % of magnesium hydroxide. In some embodiments, the third layer includes 43% to 53 wt. % of magnesium hydroxide. In some embodiments, the third layer includes 44% to 53 wt. % of magnesium hydroxide. In some embodiments, the third layer includes 45% to 53 wt. % of magnesium hydroxide. In some embodiments, the third layer includes 46% to 53 wt. % of magnesium hydroxide. In some embodiments, the third layer includes 47% to 53 wt. % of magnesium hydroxide. In some embodiments, the third layer includes 48% to 53 wt. % of magnesium hydroxide. In some embodiments, the third layer includes 49% to 53 wt. % of magnesium hydroxide. In some embodiments, the third layer includes 50% to 53 wt. % of magnesium hydroxide. In some embodiments, the third layer includes 51% to 53 wt. % of magnesium hydroxide. In some embodiments, the third layer includes 52% to 53 wt. % of magnesium hydroxide.

In some embodiments, the third layer includes 20% to 52 wt. % of magnesium hydroxide. In some embodiments, the third layer includes 25% to 52 wt. % of magnesium hydroxide. In some embodiments, the third layer includes 30% to 52 wt. % of magnesium hydroxide. In some embodiments, the third layer includes 31% to 52 wt. % of magnesium hydroxide. In some embodiments, the third layer includes 32% to 52 wt. % of magnesium hydroxide. In some embodiments, the third layer includes 33% to 52 wt. % of magnesium hydroxide. In some embodiments, the third layer includes 34% to 52 wt. % of magnesium hydroxide. In some embodiments, the third layer includes 35% to 52 wt. % of magnesium hydroxide. In some embodiments, the third layer includes 36% to 52 wt. % of magnesium hydroxide. In some embodiments, the third layer includes 37% to 52 wt. % of magnesium hydroxide. In some embodiments, the third layer includes 38% to 52 wt. % of magnesium hydroxide. In some embodiments, the third layer includes 39% to 52 wt. % of magnesium hydroxide. In some embodiments, the third layer includes 40% to 52 wt. % of magnesium hydroxide. In some embodiments, the third layer includes 41% to 52 wt. % of magnesium hydroxide. In some embodiments, the third layer includes 42% to 52 wt. % of magnesium hydroxide. In some embodiments, the third layer includes 43% to 52 wt. % of magnesium hydroxide. In some embodiments, the third layer includes 44% to 52 wt. % of magnesium hydroxide. In some embodiments, the third layer includes 45% to 52 wt. % of magnesium hydroxide. In some embodiments, the third layer includes 46% to 52 wt. % of magnesium hydroxide. In some embodiments, the third layer includes 47% to 52 wt. % of magnesium hydroxide. In some embodiments, the third layer includes 48% to 52 wt. % of magnesium hydroxide. In some embodiments, the third layer includes 49% to 52 wt. % of magnesium hydroxide. In some embodiments, the third layer includes 50% to 52 wt. % of magnesium hydroxide. In some embodiments, the third layer includes 51% to 52 wt. % of magnesium hydroxide.

In some embodiments, the third layer includes 20% to 51 wt. % of magnesium hydroxide. In some embodiments, the third layer includes 25% to 51 wt. % of magnesium hydroxide. In some embodiments, the third layer includes 30% to 51 wt. % of magnesium hydroxide. In some embodiments, the third layer includes 31% to 51 wt. % of magnesium hydroxide. In some embodiments, the third layer includes 32% to 51 wt. % of magnesium hydroxide. In some embodiments, the third layer includes 33% to 51 wt. % of magnesium hydroxide. In some embodiments, the third layer includes 34% to 51 wt. % of magnesium hydroxide. In some embodiments, the third layer includes 35% to 51 wt. % of magnesium hydroxide. In some embodiments, the third layer includes 36% to 51 wt. % of magnesium hydroxide. In some embodiments, the third layer includes 37% to 51 wt. % of magnesium hydroxide. In some embodiments, the third layer includes 38% to 51 wt. % of magnesium hydroxide. In some embodiments, the third layer includes 39% to 51 wt. % of magnesium hydroxide. In some embodiments, the third layer includes 40% to 51 wt. % of magnesium hydroxide. In some embodiments, the third layer includes 41% to 51 wt. % of magnesium hydroxide. In some embodiments, the third layer includes 42% to 51 wt. % of magnesium hydroxide. In some embodiments, the third layer includes 43% to 51 wt. % of magnesium hydroxide. In some embodiments, the third layer includes 44% to 51 wt. % of magnesium hydroxide. In some embodiments, the third layer includes 45% to 51 wt. % of magnesium hydroxide. In some embodiments, the third layer includes 46% to 51 wt. % of magnesium hydroxide. In some embodiments, the third layer includes 47% to 51 wt. % of magnesium hydroxide. In some embodiments, the third layer includes 48% to 51 wt. % of magnesium hydroxide. In some embodiments, the third layer includes 49% to 51 wt. % of magnesium hydroxide. In some embodiments, the third layer includes 50% to 51 wt. % of magnesium hydroxide.

In some embodiments, the third layer includes 20% to 50 wt. % of magnesium hydroxide. In some embodiments, the third layer includes 25% to 50 wt. % of magnesium hydroxide. In some embodiments, the third layer includes 30% to 50 wt. % of magnesium hydroxide. In some embodiments, the third layer includes 31% to 50 wt. % of magnesium hydroxide. In some embodiments, the third layer includes 32% to 50 wt. % of magnesium hydroxide. In some embodiments, the third layer includes 33% to 50 wt. % of magnesium hydroxide. In some embodiments, the third layer includes 34% to 50 wt. % of magnesium hydroxide. In some embodiments, the third layer includes 35% to 50 wt. % of magnesium hydroxide. In some embodiments, the third layer includes 36% to 50 wt. % of magnesium hydroxide. In some embodiments, the third layer includes 37% to 50 wt. % of magnesium hydroxide. In some embodiments, the third layer includes 38% to 50 wt. % of magnesium hydroxide. In some embodiments, the third layer includes 39% to 50 wt. % of magnesium hydroxide. In some embodiments, the third layer includes 40% to 50 wt. % of magnesium hydroxide. In some embodiments, the third layer includes 41% to 50 wt. % of magnesium hydroxide. In some embodiments, the third layer includes 42% to 50 wt. % of magnesium hydroxide. In some embodiments, the third layer includes 43% to 50 wt. % of magnesium hydroxide. In some embodiments, the third layer includes 44% to 50 wt. % of magnesium hydroxide. In some embodiments, the third layer includes 45% to 50 wt. % of magnesium hydroxide. In some embodiments, the third layer includes 46% to 50 wt. % of magnesium hydroxide. In some embodiments, the third layer includes 47% to 50 wt. % of magnesium hydroxide. In some embodiments, the third layer includes 48% to 50 wt. % of magnesium hydroxide. In some embodiments, the third layer includes 49% to 50 wt. % of magnesium hydroxide.

In some embodiments, the third layer includes 20% to 49 wt. % of magnesium hydroxide. In some embodiments, the third layer includes 25% to 49 wt. % of magnesium hydroxide. In some embodiments, the third layer includes 30% to 49 wt. % of magnesium hydroxide. In some embodiments, the third layer includes 31% to 49 wt. % of magnesium hydroxide. In some embodiments, the third layer includes 32% to 49 wt. % of magnesium hydroxide. In some embodiments, the third layer includes 33% to 49 wt. % of magnesium hydroxide. In some embodiments, the third layer includes 34% to 49 wt. % of magnesium hydroxide. In some embodiments, the third layer includes 35% to 49 wt. % of magnesium hydroxide. In some embodiments, the third layer includes 36% to 49 wt. % of magnesium hydroxide. In some embodiments, the third layer includes 37% to 49 wt. % of magnesium hydroxide. In some embodiments, the third layer includes 38% to 49 wt. % of magnesium hydroxide. In some embodiments, the third layer includes 39% to 49 wt. % of magnesium hydroxide. In some embodiments, the third layer includes 40% to 49 wt. % of magnesium hydroxide. In some embodiments, the third layer includes 41% to 49 wt. % of magnesium hydroxide. In some embodiments, the third layer includes 42% to 49 wt. % of magnesium hydroxide. In some embodiments, the third layer includes 43% to 49 wt. % of magnesium hydroxide. In some embodiments, the third layer includes 44% to 49 wt. % of magnesium hydroxide. In some embodiments, the third layer includes 45% to 49 wt. % of magnesium hydroxide. In some embodiments, the third layer includes 46% to 49 wt. % of magnesium hydroxide. In some embodiments, the third layer includes 47% to 49 wt. % of magnesium hydroxide. In some embodiments, the third layer includes 48% to 49 wt. % of magnesium hydroxide.

In some embodiments, the third layer includes 20% to 48 wt. % of magnesium hydroxide. In some embodiments, the third layer includes 25% to 48 wt. % of magnesium hydroxide. In some embodiments, the third layer includes 30% to 48 wt. % of magnesium hydroxide. In some embodiments, the third layer includes 31% to 48 wt. % of magnesium hydroxide. In some embodiments, the third layer includes 32% to 48 wt. % of magnesium hydroxide. In some embodiments, the third layer includes 33% to 48 wt. % of magnesium hydroxide. In some embodiments, the third layer includes 34% to 48 wt. % of magnesium hydroxide. In some embodiments, the third layer includes 35% to 48 wt. % of magnesium hydroxide. In some embodiments, the third layer includes 36% to 48 wt. % of magnesium hydroxide. In some embodiments, the third layer includes 37% to 48 wt. % of magnesium hydroxide. In some embodiments, the third layer includes 38% to 48 wt. % of magnesium hydroxide. In some embodiments, the third layer includes 39% to 48 wt. % of magnesium hydroxide. In some embodiments, the third layer includes 40% to 48 wt. % of magnesium hydroxide. In some embodiments, the third layer includes 41% to 48 wt. % of magnesium hydroxide. In some embodiments, the third layer includes 42% to 48 wt. % of magnesium hydroxide. In some embodiments, the third layer includes 43% to 48 wt. % of magnesium hydroxide. In some embodiments, the third layer includes 44% to 48 wt. % of magnesium hydroxide. In some embodiments, the third layer includes 45% to 48 wt. % of magnesium hydroxide. In some embodiments, the third layer includes 46% to 48 wt. % of magnesium hydroxide. In some embodiments, the third layer includes 47% to 48 wt. % of magnesium hydroxide.

In some embodiments, the third layer includes 20% to 47 wt. % of magnesium hydroxide. In some embodiments, the third layer includes 25% to 47 wt. % of magnesium hydroxide. In some embodiments, the third layer includes 30% to 47 wt. % of magnesium hydroxide. In some embodiments, the third layer includes 31% to 47 wt. % of magnesium hydroxide. In some embodiments, the third layer includes 32% to 47 wt. % of magnesium hydroxide. In some embodiments, the third layer includes 33% to 47 wt. % of magnesium hydroxide. In some embodiments, the third layer includes 34% to 47 wt. % of magnesium hydroxide. In some embodiments, the third layer includes 35% to 47 wt. % of magnesium hydroxide. In some embodiments, the third layer includes 36% to 47 wt. % of magnesium hydroxide. In some embodiments, the third layer includes 37% to 47 wt. % of magnesium hydroxide. In some embodiments, the third layer includes 38% to 47 wt. % of magnesium hydroxide. In some embodiments, the third layer includes 39% to 47 wt. % of magnesium hydroxide. In some embodiments, the third layer includes 40% to 47 wt. % of magnesium hydroxide. In some embodiments, the third layer includes 41% to 47 wt. % of magnesium hydroxide. In some embodiments, the third layer includes 42% to 47 wt. % of magnesium hydroxide. In some embodiments, the third layer includes 43% to 47 wt. % of magnesium hydroxide. In some embodiments, the third layer includes 44% to 47 wt. % of magnesium hydroxide. In some embodiments, the third layer includes 45% to 47 wt. % of magnesium hydroxide. In some embodiments, the third layer includes 46% to 47 wt. % of magnesium hydroxide.

In some embodiments, the third layer includes 20% to 46 wt. % of magnesium hydroxide. In some embodiments, the third layer includes 25% to 46 wt. % of magnesium hydroxide. In some embodiments, the third layer includes 30% to 46 wt. % of magnesium hydroxide. In some embodiments, the third layer includes 31% to 46 wt. % of magnesium hydroxide. In some embodiments, the third layer includes 32% to 46 wt. % of magnesium hydroxide. In some embodiments, the third layer includes 33% to 46 wt. % of magnesium hydroxide. In some embodiments, the third layer includes 34% to 46 wt. % of magnesium hydroxide. In some embodiments, the third layer includes 35% to 46 wt. % of magnesium hydroxide. In some embodiments, the third layer includes 36% to 46 wt. % of magnesium hydroxide. In some embodiments, the third layer includes 37% to 46 wt. % of magnesium hydroxide. In some embodiments, the third layer includes 38% to 46 wt. % of magnesium hydroxide. In some embodiments, the third layer includes 39% to 46 wt. % of magnesium hydroxide. In some embodiments, the third layer includes 40% to 46 wt. % of magnesium hydroxide. In some embodiments, the third layer includes 41% to 46 wt. % of magnesium hydroxide. In some embodiments, the third layer includes 42% to 46 wt. % of magnesium hydroxide. In some embodiments, the third layer includes 43% to 46 wt. % of magnesium hydroxide. In some embodiments, the third layer includes 44% to 46 wt. % of magnesium hydroxide. In some embodiments, the third layer includes 45% to 46 wt. % of magnesium hydroxide.

In some embodiments, the third layer includes 20% to 45 wt. % of magnesium hydroxide. In some embodiments, the third layer includes 25% to 45 wt. % of magnesium hydroxide. In some embodiments, the third layer includes 30% to 45 wt. % of magnesium hydroxide. In some embodiments, the third layer includes 31% to 45 wt. % of magnesium hydroxide. In some embodiments, the third layer includes 32% to 45 wt. % of magnesium hydroxide. In some embodiments, the third layer includes 33% to 45 wt. % of magnesium hydroxide. In some embodiments, the third layer includes 34% to 45 wt. % of magnesium hydroxide. In some embodiments, the third layer includes 35% to 45 wt. % of magnesium hydroxide. In some embodiments, the third layer includes 36% to 45 wt. % of magnesium hydroxide. In some embodiments, the third layer includes 37% to 45 wt. % of magnesium hydroxide. In some embodiments, the third layer includes 38% to 45 wt. % of magnesium hydroxide. In some embodiments, the third layer includes 39% to 45 wt. % of magnesium hydroxide. In some embodiments, the third layer includes 40% to 45 wt. % of magnesium hydroxide. In some embodiments, the third layer includes 41% to 45 wt. % of magnesium hydroxide. In some embodiments, the third layer includes 42% to 45 wt. % of magnesium hydroxide. In some embodiments, the third layer includes 43% to 45 wt. % of magnesium hydroxide. In some embodiments, the third layer includes 44% to 45 wt. % of magnesium hydroxide.

In some embodiments, the third layer includes 20% to 44 wt. % of magnesium hydroxide. In some embodiments, the third layer includes 25% to 44 wt. % of magnesium hydroxide. In some embodiments, the third layer includes 30% to 44 wt. % of magnesium hydroxide. In some embodiments, the third layer includes 31% to 44 wt. % of magnesium hydroxide. In some embodiments, the third layer includes 32% to 44 wt. % of magnesium hydroxide. In some embodiments, the third layer includes 33% to 44 wt. % of magnesium hydroxide. In some embodiments, the third layer includes 34% to 44 wt. % of magnesium hydroxide. In some embodiments, the third layer includes 35% to 44 wt. % of magnesium hydroxide. In some embodiments, the third layer includes 36% to 44 wt. % of magnesium hydroxide. In some embodiments, the third layer includes 37% to 44 wt. % of magnesium hydroxide. In some embodiments, the third layer includes 38% to 44 wt. % of magnesium hydroxide. In some embodiments, the third layer includes 39% to 44 wt. % of magnesium hydroxide. In some embodiments, the third layer includes 40% to 44 wt. % of magnesium hydroxide. In some embodiments, the third layer includes 41% to 44 wt. % of magnesium hydroxide.

In some embodiments, the third layer includes 42% to 44 wt. % of magnesium hydroxide. In some embodiments, the third layer includes 43% to 44 wt. % of magnesium hydroxide.

In some embodiments, the third layer includes 20% to 43 wt. % of magnesium hydroxide. In some embodiments, the third layer includes 25% to 43 wt. % of magnesium hydroxide. In some embodiments, the third layer includes 30% to 43 wt. % of magnesium hydroxide. In some embodiments, the third layer includes 31% to 43 wt. % of magnesium hydroxide. In some embodiments, the third layer includes 32% to 43 wt. % of magnesium hydroxide. In some embodiments, the third layer includes 33% to 43 wt. % of magnesium hydroxide. In some embodiments, the third layer includes 34% to 43 wt. % of magnesium hydroxide. In some embodiments, the third layer includes 35% to 43 wt. % of magnesium hydroxide. In some embodiments, the third layer includes 36% to 43 wt. % of magnesium hydroxide. In some embodiments, the third layer includes 37% to 43 wt. % of magnesium hydroxide. In some embodiments, the third layer includes 38% to 43 wt. % of magnesium hydroxide. In some embodiments, the third layer includes 39% to 43 wt. % of magnesium hydroxide. In some embodiments, the third layer includes 40% to 43 wt. % of magnesium hydroxide. In some embodiments, the third layer includes 41% to 43 wt. % of magnesium hydroxide. In some embodiments, the third layer includes 42% to 43 wt. % of magnesium hydroxide.

In some embodiments, the third layer includes 20% to 42 wt. % of magnesium hydroxide. In some embodiments, the third layer includes 25% to 42 wt. % of magnesium hydroxide. In some embodiments, the third layer includes 30% to 42 wt. % of magnesium hydroxide. In some embodiments, the third layer includes 31% to 42 wt. % of magnesium hydroxide. In some embodiments, the third layer includes 32% to 42 wt. % of magnesium hydroxide. In some embodiments, the third layer includes 33% to 42 wt. % of magnesium hydroxide. In some embodiments, the third layer includes 34% to 42 wt. % of magnesium hydroxide. In some embodiments, the third layer includes 35% to 42 wt. % of magnesium hydroxide. In some embodiments, the third layer includes 36% to 42 wt. % of magnesium hydroxide. In some embodiments, the third layer includes 37% to 42 wt. % of magnesium hydroxide. In some embodiments, the third layer includes 38% to 42 wt. % of magnesium hydroxide. In some embodiments, the third layer includes 39% to 42 wt. % of magnesium hydroxide. In some embodiments, the third layer includes 40% to 42 wt. % of magnesium hydroxide. In some embodiments, the third layer includes 41% to 42 wt. % of magnesium hydroxide.

In some embodiments, the third layer includes 20% to 41 wt. % of magnesium hydroxide. In some embodiments, the third layer includes 25% to 41 wt. % of magnesium hydroxide. In some embodiments, the third layer includes 30% to 41 wt. % of magnesium hydroxide. In some embodiments, the third layer includes 31% to 41 wt. % of magnesium hydroxide. In some embodiments, the third layer includes 32% to 41 wt. % of magnesium hydroxide. In some embodiments, the third layer includes 33% to 41 wt. % of magnesium hydroxide. In some embodiments, the third layer includes 34% to 41 wt. % of magnesium hydroxide. In some embodiments, the third layer includes 35% to 41 wt. % of magnesium hydroxide. In some embodiments, the third layer includes 36% to 41 wt. % of magnesium hydroxide. In some embodiments, the third layer includes 37% to 41 wt. % of magnesium hydroxide. In some embodiments, the third layer includes 38% to 41 wt. % of magnesium hydroxide. In some embodiments, the third layer includes 39% to 41 wt. % of magnesium hydroxide. In some embodiments, the third layer includes 40% to 41 wt. % of magnesium hydroxide.

In some embodiments, the third layer includes 20% to 40 wt. % of magnesium hydroxide. In some embodiments, the third layer includes 25% to 40 wt. % of magnesium hydroxide. In some embodiments, the third layer includes 30% to 40 wt. % of magnesium hydroxide. In some embodiments, the third layer includes 31% to 40 wt. % of magnesium hydroxide. In some embodiments, the third layer includes 32% to 40 wt. % of magnesium hydroxide. In some embodiments, the third layer includes 33% to 40 wt. % of magnesium hydroxide. In some embodiments, the third layer includes 34% to 40 wt. % of magnesium hydroxide. In some embodiments, the third layer includes 35% to 40 wt. % of magnesium hydroxide. In some embodiments, the third layer includes 36% to 40 wt. % of magnesium hydroxide. In some embodiments, the third layer includes 37% to 40 wt. % of magnesium hydroxide. In some embodiments, the third layer includes 38% to 40 wt. % of magnesium hydroxide. In some embodiments, the third layer includes 39% to 40 wt. % of magnesium hydroxide.

In some embodiments, the third layer includes 20% to 39 wt. % of magnesium hydroxide. In some embodiments, the third layer includes 25% to 39 wt. % of magnesium hydroxide. In some embodiments, the third layer includes 30% to 39 wt. % of magnesium hydroxide. In some embodiments, the third layer includes 31% to 39 wt. % of magnesium hydroxide. In some embodiments, the third layer includes 32% to 39 wt. % of magnesium hydroxide. In some embodiments, the third layer includes 33% to 39 wt. % of magnesium hydroxide. In some embodiments, the third layer includes 34% to 39 wt. % of magnesium hydroxide. In some embodiments, the third layer includes 35% to 39 wt. % of magnesium hydroxide. In some embodiments, the third layer includes 36% to 39 wt. % of magnesium hydroxide. In some embodiments, the third layer includes 37% to 39 wt. % of magnesium hydroxide. In some embodiments, the third layer includes 38% to 39 wt. % of magnesium hydroxide.

In some embodiments, the third layer includes 20% to 38 wt. % of magnesium hydroxide. In some embodiments, the third layer includes 25% to 38 wt. % of magnesium hydroxide. In some embodiments, the third layer includes 30% to 38 wt. % of magnesium hydroxide. In some embodiments, the third layer includes 31% to 38 wt. % of magnesium hydroxide. In some embodiments, the third layer includes 32% to 38 wt. % of magnesium hydroxide. In some embodiments, the third layer includes 33% to 38 wt. % of magnesium hydroxide. In some embodiments, the third layer includes 34% to 38 wt. % of magnesium hydroxide. In some embodiments, the third layer includes 35% to 38 wt. % of magnesium hydroxide. In some embodiments, the third layer includes 36% to 38 wt. % of magnesium hydroxide. In some embodiments, the third layer includes 37% to 38 wt. % of magnesium hydroxide.

In some embodiments, the third layer includes 20% to 37 wt. % of magnesium hydroxide. In some embodiments, the third layer includes 25% to 37 wt. % of magnesium hydroxide. In some embodiments, the third layer includes 30% to 37 wt. % of magnesium hydroxide. In some embodiments, the third layer includes 31% to 37 wt. % of magnesium hydroxide. In some embodiments, the third layer includes 32% to 37 wt. % of magnesium hydroxide. In some embodiments, the third layer includes 33% to 37 wt. % of magnesium hydroxide. In some embodiments, the third layer includes 34% to 37 wt. % of magnesium hydroxide. In some embodiments, the third layer includes 35% to 37 wt. % of magnesium hydroxide. In some embodiments, the third layer includes 36% to 37 wt. % of magnesium hydroxide.

In some embodiments, the third layer includes 20% to 36 wt. % of magnesium hydroxide. In some embodiments, the third layer includes 25% to 36 wt. % of magnesium hydroxide. In some embodiments, the third layer includes 30% to 36 wt. % of magnesium hydroxide. In some embodiments, the third layer includes 31% to 36 wt. % of magnesium hydroxide. In some embodiments, the third layer includes 32% to 36 wt. % of magnesium hydroxide. In some embodiments, the third layer includes 33% to 36 wt. % of magnesium hydroxide. In some embodiments, the third layer includes 34% to 36 wt. % of magnesium hydroxide. In some embodiments, the third layer includes 35% to 36 wt. % of magnesium hydroxide.

In some embodiments, the third layer includes 20% to 35 wt. % of magnesium hydroxide. In some embodiments, the third layer includes 25% to 35 wt. % of magnesium hydroxide. In some embodiments, the third layer includes 30% to 35 wt. % of magnesium hydroxide. In some embodiments, the third layer includes 31% to 35 wt. % of magnesium hydroxide. In some embodiments, the third layer includes 32% to 35 wt. % of magnesium hydroxide. In some embodiments, the third layer includes 33% to 35 wt. % of magnesium hydroxide. In some embodiments, the third layer includes 34% to 35 wt. % of magnesium hydroxide.

In some embodiments, the third layer includes 20% to 34 wt. % of magnesium hydroxide. In some embodiments, the third layer includes 25% to 34 wt. % of magnesium hydroxide. In some embodiments, the third layer includes 30% to 34 wt. % of magnesium hydroxide. In some embodiments, the third layer includes 31% to 34 wt. % of magnesium hydroxide. In some embodiments, the third layer includes 32% to 34 wt. % of magnesium hydroxide. In some embodiments, the third layer includes 33% to 34 wt. % of magnesium hydroxide.

In some embodiments, the third layer includes 20% to 33 wt. % of magnesium hydroxide. In some embodiments, the third layer includes 25% to 33 wt. % of magnesium hydroxide. In some embodiments, the third layer includes 30% to 33 wt. % of magnesium hydroxide. In some embodiments, the third layer includes 31% to 33 wt. % of magnesium hydroxide. In some embodiments, the third layer includes 32% to 33 wt. % of magnesium hydroxide.

In some embodiments, the third layer includes 20% to 32 wt. % of magnesium hydroxide. In some embodiments, the third layer includes 25% to 32 wt. % of magnesium hydroxide. In some embodiments, the third layer includes 30% to 32 wt. % of magnesium hydroxide. In some embodiments, the third layer includes 31% to 32 wt. % of magnesium hydroxide.

In some embodiments, the third layer includes 20% to 31 wt. % of magnesium hydroxide. In some embodiments, the third layer includes 25% to 31 wt. % of magnesium hydroxide. In some embodiments, the third layer includes 30% to 31 wt. % of magnesium hydroxide.

In some embodiments, the third layer includes 20% to 30 wt. % of magnesium hydroxide. In some embodiments, the third layer includes 25% to 30 wt. % of magnesium hydroxide. In some embodiments, the third layer includes 20% to 25 wt. % of magnesium hydroxide.

In some embodiments, one or more of the layers includes calcium carbonate. In some embodiments, one or more of the layers omits calcium carbonate.

In some embodiments, the first layer is configured to be an uppermost layer when the roofing membrane in installed.

In some embodiments, the scrim material does not include a glass material. In some embodiments, the scrim material includes a glass material. In some embodiments, the scrim includes a fiberglass material. In some embodiments, the scrim includes a polymer material. In some embodiments, the polymer material includes a polypropylene material. In some embodiments, the polymer material includes a polyester material.

In some embodiments, the first layer contacts and at least partially covers the second layer. In some embodiments, the first layer contacts and entirely covers the second layer. In some embodiments, the first layer does not contact the second layer.

In some embodiments, the second layer contacts and at least partially covers the third layer. In some embodiments, the second layer contacts and entirely covers the third layer. In some embodiments, the second layer does not contact the third layer.

In some embodiments, the present invention provides a roofing system, including a roofing substrate and a roofing membrane directly on the roofing substrate.

In some embodiments, the roofing substrate includes an expanded polystyrene material. In some embodiments, the expanded polystyrene material has a thickness of at least 0.5″ or above.

In some embodiments, roofing substrate include a polyisocyanurate material, an EPS material, a gypsum material, and combinations thereof. In some embodiments, the polyisocyanurate material has a thickness of at least 0.5″ or above.

In some embodiments, the roofing membrane contacts the roofing substrate, such that there is no intervening layer between the roofing substrate and the roofing membrane.

In some embodiments, there is a sufficient amount of the magnesium hydroxide in the first layer and the third layer such that one or more of the roofing membrane installed above the substrate, the fire resistant layer, and/or the substrate tested in accordance with European fire testing standards BRoof (t2) or (t3) passes the testing.

In some embodiments, the present invention provides a roofing system, including: a roofing substrate; a fire-resistant layer directly on the roofing substrate; and a roofing membrane directly on the fire-resistant layer, such that the fire-resistant layer is between the roofing substrate and the roofing membrane.

In some embodiments, the fire-resistant layer includes glass fleece. In some embodiments, the fire-resistant layer includes GAF TigerPaw. In some embodiments, the fire-resistant layer includes Versashield Solo. In some embodiments, the fire-resistant layer includes a non-combustible barrier. In some embodiments, the fire-resistant layer has a thickness of 60 mil.

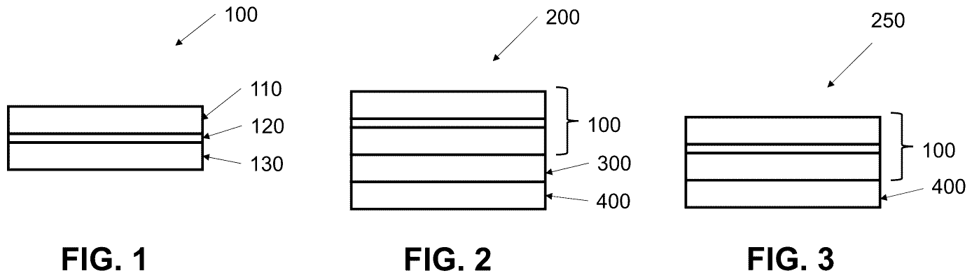

With reference to the drawings, FIG. 1 is a schematic showing a cross-sectional view of the roofing membrane as described above, in accordance with some embodiments of the invention. As shown in FIG. 1, in some embodiments, a roofing membrane 100 may include a first layer 110, a second layer 120, and a third layer 130.

In some embodiments, one or more, or all, of the first layer 110, the second layer 120, and/or the third layer 130 may be in accordance with the first layer, the second layer, and/or the third layer as described above. For example, in some embodiments, the first layer 110 may be configured to be an uppermost layer when the roofing membrane is installed above or on a roof deck, and may include thermoplastic polyolefin (TPO) and magnesium hydroxide; the second layer 120 may include a scrim material; and the third layer 130 may include thermoplastic polyolefin (TPO) and magnesium hydroxide.

FIG. 2 is a schematic showing a cross-sectional view of a roofing system including the roofing membrane, the fire-resistant layer, and the substrate as described above, in accordance with some embodiments of the invention. As shown in FIG. 2, in some embodiments, a roofing system 200 may include the roofing membrane 100, a fire-resistant layer 300, and a substrate 400. In some embodiments, one or more, or all, of the roofing membrane 100, the roofing system 200, the fire-resistant layer 300, and/or the substrate 400 may be in accordance with the roofing membrane, the roofing system, the fire-resistant layer, and/or the substrate as described above. For example, in some embodiments, the fire-resistant layer 300 may be a glass-fleece, and/or the substrate 400 may be expanded polystyrene or polyisocyanurate. In some embodiments, as described, the roofing system 200 may be installed above or on a roof or a roof deck.

FIG. 3 is a schematic showing a cross-sectional view of a roofing system including the roofing membrane and the substrate as described above, in accordance with some embodiments of the invention. As shown in FIG. 3, in some embodiments, a roofing system 250 may include the roofing membrane 100 and a substrate 400—thus, the embodiment of FIG. 3 may be similar to that of FIG. 2, but without a fire-resistant layer 300. In some embodiments, one or more, or all, of the roofing membrane 100, the roofing system 250, and/or the substrate 400 may be in accordance with the roofing membrane, the roofing system, and/or the substrate as described above. For example, in some embodiments. In some embodiments, as described, the roofing system 250 may be installed above or on a roof or a roof deck.

Variations, modifications, and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A roofing membrane, comprising:
a first layer,
wherein the first layer comprises:
30 wt. % to 65 wt. %, based on a total weight of the first layer, of magnesium hydroxide, and
a thermoplastic polyolefin (TPO);
a second layer,
wherein the second layer comprises a scrim material,
wherein the scrim material comprises a polyester material; and
a third layer,
wherein the second layer is between the first layer and the third layer,
wherein the third layer comprises:
30 wt. % to 65 wt. %, based on a total weight of the third layer, of magnesium hydroxide, and
a thermoplastic polyolefin (TPO).

2. The roofing membrane of claim 1, wherein the scrim material does not include a glass material.

3. The roofing membrane of claim 1, wherein the first layer contacts and at least partially covers the second layer.

4. The roofing membrane of claim 1, wherein the second layer contacts and at least partially covers the third layer.

5. The roofing membrane of claim 1, wherein the first layer comprises 42 wt. % to 60 wt. %, based on the total weight of the first layer, of magnesium hydroxide.

6. The roofing membrane of claim 1, wherein the third layer comprises 42 wt. % to 60 wt. %, based on the total weight of the first layer, of magnesium hydroxide.

7. A roofing system, comprising:
a roofing substrate; and
a roofing membrane installed on the roofing substrate, the roofing membrane comprising:
a first layer,
wherein the first layer comprises:
30 wt. % to 65 wt. %, based on a total weight of the first layer, of magnesium hydroxide, and
a thermoplastic polyolefin (TPO);
a second layer,
wherein the second layer comprises a scrim material,
wherein the scrim material comprises a polyester material; and
a third layer,
wherein the second layer is between the first layer and the third layer,
wherein the third layer comprises:
30 wt. % to 65 wt. %, based on a total weight of the third layer, of magnesium hydroxide, and
a thermoplastic polyolefin (TPO);,
wherein there is a sufficient amount of the magnesium hydroxide in the first layer and the third layer such that when the roofing membrane installed above the roofing substrate is tested in accordance with European fire testing standards Broof(T2) Test, the roofing system passes the testing.

8. The roofing system of claim 7, wherein the roofing substrate comprises an expanded polystyrene material.

9. The roofing system of claim 8, wherein the expanded polystyrene material has a thickness of at least 0.5″ or above.

10. The roofing system of claim 7, wherein roofing substrate comprise a polyisocyanurate material.

11. The roofing system of claim 10, wherein the polyisocyanurate material has a thickness of at least 0.5″ or above.

12. The roofing system of claim 7, wherein the roofing membrane contacts the roofing substrate, such that there is no intervening layer between the roofing substrate and the roofing membrane.

13. The roofing system of claim 7, wherein the scrim material does not include a glass material.

14. The roofing system of claim 7, wherein the first layer contacts the second layer.

15. The roofing system of claim 7, wherein the second layer contacts the third layer.

16. A roofing system, comprising:
a roofing substrate;
a fire-resistant layer installed on the roofing substrate; and
a roofing membrane installed on the fire-resistant layer,
wherein the fire-resistant layer is between the roofing substrate and the roofing membrane,
wherein the roofing membrane comprises:
a first layer,
wherein the first layer comprises:
30 wt. % to 65 wt. %, based on a total weight of the first layer, of magnesium hydroxide, and
a thermoplastic polyolefin (TPO);
a second layer,
wherein the second layer comprises a scrim material,
wherein the scrim material comprises a polyester material; and
a third layer,
wherein the second layer is between the first layer and the third layer,
wherein the third layer comprises:
30 wt. % to 65 wt. %, based on a total weight of the third layer, of magnesium hydroxide, and
a thermoplastic polyolefin (TPO),
wherein there is a sufficient amount of the magnesium hydroxide in the first layer and the third layer such that when the roofing membrane installed above the roofing substrate is tested in accordance with European fire testing standards Broof(T2) Test, the roofing system passes the testing.

17. The roofing system of claim 16, wherein fire-resistant layer comprises glass fleece.

18. The roofing system of claim 16, wherein the fire-resistant layer has a thickness of 60 mil.

19. The roofing system of claim 16, wherein the scrim material does not include a glass material.

20. The roofing system of claim 16, wherein the first layer contacts the second layer, wherein the second layer contacts the third layer.
